(19) United States
(12) Patent Application Publication
(10) Pub. No.: US 2024/0207950 A1
(43) Pub. Date: Jun. 27, 2024

(54) POCKET HOLE JIG SYSTEM HAVING ANGLED STATIONARY UPRIGHT

(71) Applicant: Kreg Enterprises, Inc., Ankeny, IA (US)

(72) Inventors: Mike Marusiak, Ankeny, IA (US); Elliot Hoff, Ames, IA (US); Andrew Lyons, Grimes, IA (US); Paul Eilts, Ankeny, IA (US); Zachary Scheuffele, Ames, IA (US); Kevin Choi, Ames, IA (US); Scott Schaaf, Ankeny, IA (US); Ethan Andersen, Bondurant, IA (US); Nathan Hagarty, Ames, IA (US); Jenna Clark, Clare, IA (US); Caleb Dirks, Iowa City, IA (US)

(21) Appl. No.: 18/544,754

(22) Filed: Dec. 19, 2023

Related U.S. Application Data
(60) Provisional application No. 63/434,144, filed on Dec. 21, 2022.

(51) Int. Cl. B23B 47/28

(52) U.S. Cl. CPC B23B 47/287

(57) ABSTRACT

In one or more arrangements, a pocket hole jig system having a stationary upright is presented. In one or more arrangements, the pocket hole jig system has a base, an upright assembly having a guide, a clamping assembly having a handle portion and a workpiece support member, and a drill guide assembly. In one or more arrangements, the guide of the upright assembly provides a path of travel for the drill guide assembly downward and forward towards the workpiece support member at an angle and upward and away from the workpiece support member at an angle, and wherein the workpiece support member is configured to move in a path parallel to the generally planar work surface of the upper surface of the base. In one or more arrangements, the workpiece support member is configured to travel a fixed distance between a fully disengaged position to a fully clamped position.

### RELATED APPLICATION

This application claims priority to U.S. Provisional Patent Application No. 63/434,144 filed Dec. 21, 2022 and titled “POCKET HOLE JIG SYSTEM HAVING ANGLED STATIONARY UPRIGHT,” the disclosure of which is hereby incorporated in its entirety.

### FIELD OF THE DISCLOSURE

This disclosure relates generally to holding systems. More specifically, and without limitation, this disclosure relates to adjustable holding systems, such as jigs, and methods of using the same.

### OVERVIEW OF THE DISCLOSURE

Pocket hole wood joinery involves joining boards by inserting a fastener at an angle through the edge of one board into the other. Such joints are commonly used for face frames, cabinet boxes, leg-to-rail joinery in chairs and tables, and so forth. Drill guides or jigs are used to drill the holes through which the fasteners or pocket screws are inserted into the adjoining workpiece.

To facilitate the formation of pocket hole joinery, Applicant, Kreg Tool Company, offers a line of pocket hole jigs. These pocket hole jigs are configured to clamp a workpiece in place and help guide a stepped drill bit at an angle into a workpiece thereby forming a pocket hole in the workpiece. The pocket hole formed by this process is configured to receive a screw that is used to screw two workpieces together.

Existing jigs for use forming pocket hole joinery have a variety of configurations and operate in a variety of manners. These configurations and manners of operation leave much to be desired. In addition, all of the existing pocket hole jigs available have deficiencies and therefore are not well suited for various applications, and they are unnecessarily time consuming or they are unnecessarily inefficient to use in various circumstances.

Therefore, for the reasons stated above, and the reasons stated below, there is a need in the art for an improved adjustable holding system. Thus, it is a primary objective of the disclosure to provide a pocket hole jig system that improves upon the state of the art.

Another object of the invention is to provide a pocket hole jig that quickly adjusts to various sized workpieces.

Yet another object of the invention is to provide a pocket hole jig that is easy to use.

Another object of the invention is to provide a pocket hole jig that is efficient.

Yet another object of the invention is to provide a pocket hole jig that is quick to use.

Another object of the invention is to provide a pocket hole jig that is inexpensive to produce.

Yet another object of the invention is to provide a pocket hole jig that is durable and rigid and robust in design, function and use.

Another object of the invention is to provide a pocket hole jig that presents an improved manner and method of setting the length of pocket holes.

Yet another object of the invention is to provide a pocket hole jig that can be used with any type of workpiece.

Another object of the invention is to provide a pocket hole jig that forms accurate pocket holes.

Yet another object of the invention is to provide a pocket hole jig that is safe to use.

Another object of the invention is to provide a pocket hole jig that has a long useful life.

Yet another object of the invention is to provide a pocket hole jig that is quick to adjust to account for various workpiece thicknesses.

Another object of the invention is to provide a pocket hole jig that is easy to adjust to account for various workpiece thicknesses.

Yet another object of the invention is to provide a pocket hole jig that is efficient to adjust to account for various workpiece thicknesses.

These and other objects, features, or advantages of the disclosure will become apparent from the specification, figures, and claims.

### SUMMARY OF THE DISCLOSURE

In one or more arrangements, a pocket hole jig system having a stationary upright is presented. In one or more arrangements, the pocket hole jig system has a base, an upright assembly having a guide, a clamping assembly having a handle portion and a workpiece support member, and a drill guide assembly. In one or more arrangements, the guide of the upright assembly provides a path of travel for the drill guide assembly downward and forward towards the workpiece support member at an angle and upward and away from the workpiece support member at an angle, and wherein the workpiece support member is configured to move in a path parallel to the generally planar work surface of the upper surface of the base. In one or more arrangements, the workpiece support member is configured to travel a fixed distance between a fully disengaged position to a fully clamped position.

### BRIEF DESCRIPTION OF THE FIGURES

FIG. 1 shows an upper right isometric view of an embodiment of a pocket hole jig system.

FIG. 2 shows an upper right isometric exploded view of an embodiment of a pocket hole jig system.

FIG. 3 shows an upper left isometric view of an embodiment of a pocket hole jig system.

FIG. 4 shows a rear right isometric view of an embodiment of a pocket hole jig system.

FIG. 5 shows a lower right front isometric view of an embodiment of a pocket hole jig system.

FIG. 6 shows a right side elevation view of an embodiment of a pocket hole jig system.

FIG. 7 shows a left side elevation view of an embodiment of a pocket hole jig system.

FIG. 8 shows a right side elevation view of an embodiment of a pocket hole jig system.

FIG. 9 shows a top plan view of an embodiment of a pocket hole jig system.

FIG. 10 shows a rear elevation view of an embodiment of a pocket hole jig system.

FIG. 11 shows a right rear elevated isometric view of a base plate of an embodiment of a pocket hole jig system.

FIG. 12 shows a left front elevated isometric view of a base plate of an embodiment of a pocket hole jig system.

FIG. 13 shows an upper left front isometric view of a drill guide assembly of an embodiment of a pocket hole jig system.

FIG. 14 shows a lower left rear isometric view of a drill guide assembly of an embodiment of a pocket hole jig system.

FIG. 15 shows a front elevation view of a drill guide assembly of an embodiment of a pocket hole jig system.

FIG. 16 shows a right side elevation view of a drill guide assembly of an embodiment of a pocket hole jig system.

FIG. 17 shows a left side elevation view of a drill guide assembly of an embodiment of a pocket hole jig system.

FIG. 18 shows an upper left front isometric view of an upright assembly of an embodiment of a pocket hole jig system.

FIG. 19 shows a right side elevation view of an upright assembly of an embodiment of a pocket hole jig system.

FIG. 20 shows a left side elevation view of an upright assembly of an embodiment of a pocket hole jig system.

FIG. 21 shows a front elevation view of an upright assembly of an embodiment of a pocket hole jig system.

FIG. 22 shows a top plan view of an upright assembly of an embodiment of a pocket hole jig system.

FIG. 23 shows a rear elevation view of a workpiece support member of an embodiment of a pocket hole jig system.

FIG. 24 shows a front elevation view of a workpiece support member of an embodiment of a pocket hole jig system.

FIG. 25 shows a left side elevation view of a workpiece support member of an embodiment of a pocket hole jig system.

FIG. 26 shows a right rear elevated view of a workpiece support member of an embodiment of a pocket hole jig system.

FIG. 27 shows a left side elevation view of an embodiment of a pocket hole jig system with the handle in the lower position.

FIG. 28 shows a left front elevated view of an embodiment of a pocket hole jig system with the handle in the lower position.

FIG. 29 shows a top plan view of an embodiment of a pocket hole jig system with the handle in the lower position.

FIG. 30 shows a left front elevated view of a handle portion of an embodiment of a pocket hole jig system.

FIG. 31 shows a left front elevated view of an embodiment of a pocket hole jig system with the handle in the lower position and a workpiece held in the system.

FIG. 32 shows a right rear elevated view of a workpiece support member of an embodiment of a pocket hole jig system with the handle in the lower position and a workpiece held in the system.

FIG. 33 shows a left side elevation view of an embodiment of a pocket hole jig system with the handle in the lower position and a workpiece held in the system.

FIG. 34 shows a top plan view of an embodiment of a pocket hole jig system with the handle in the lower position and a workpiece held in the system.

FIG. 35 shows a left front elevated view of an embodiment of a pocket hole jig system with the handle in the lower position and another workpiece held in the system.

FIG. 36 shows a right rear elevated view of a workpiece support member of an embodiment of a pocket hole jig system with the handle in the lower position and another workpiece held in the system.

FIG. 37 shows a left side elevation view of an embodiment of a pocket hole jig system with the handle in the lower position and another workpiece held in the system.

FIG. 38 shows a top plan view of an embodiment of a pocket hole jig system with the handle in the lower position and another workpiece held in the system.

FIG. 39 shows a left front elevated view of another embodiment of a pocket hole jig system.

FIG. 40 shows a left front elevated exploded view of another embodiment of a pocket hole jig system.

FIG. 41 shows a right rear elevated view of another embodiment of a pocket hole jig system.

FIG. 42 shows a right rear lower view of another embodiment of a pocket hole jig system.

FIG. 43 shows a left front lower view of another embodiment of a pocket hole jig system.

FIG. 44 shows a front elevation view of another embodiment of a pocket hole jig system.

FIG. 45 shows a rear elevation view of another embodiment of a pocket hole jig system.

FIG. 46 shows a right side elevation view of another embodiment of a pocket hole jig system.

FIG. 47 shows a left side elevation view of another embodiment of a pocket hole jig system.

FIG. 48 shows a top plan view of another embodiment of a pocket hole jig system.

FIG. 49 shows a right front elevated view of a drill guide assembly of another embodiment of a pocket hole jig system.

FIG. 50 shows a left rear elevated view of a drill guide assembly of another embodiment of a pocket hole jig system.

FIG. 51 shows a left front lower view of a drill guide assembly of another embodiment of a pocket hole jig system.

FIG. 52 shows a right rear lower view of a drill guide assembly of another embodiment of a pocket hole jig system.

FIG. 53 shows a top plan view of a drill guide assembly of another embodiment of a pocket hole jig system.

FIG. 54 shows a right side elevation view of a drill guide assembly of another embodiment of a pocket hole jig system.

FIG. 55 shows a left side elevation view of a drill guide assembly of another embodiment of a pocket hole jig system.

FIG. 56 shows a right rear elevated view of a workpiece support member of another embodiment of a pocket hole jig assembly.

FIG. 57 shows an isometric view of a guide for an upright assembly of another embodiment of a pocket hole jig assembly.

FIG. 58 shows a left front elevated view of another embodiment of a pocket hole jig system with a workpiece held in the system.

FIG. 59 shows a right rear elevated view of another embodiment of a pocket hole jig system with a workpiece held in the system.

FIG. 60 shows a left side elevation view of another embodiment of a pocket hole jig system with a workpiece held in the system.

FIG. 61 shows a top plan view of another embodiment of a pocket hole jig system with a workpiece held in the system.

FIG. 62 shows a left front elevated view of another embodiment of a pocket hole jig system with another workpiece held in the system.

FIG. 63 shows a right rear elevated view of another embodiment of a pocket hole jig system with another workpiece held in the system.

FIG. 64 shows a left side elevation view of another embodiment of a pocket hole jig system with another workpiece held in the system.

FIG. 65 shows a top plan view of another embodiment of a pocket hole jig system with another workpiece held in the system.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of creating pocket holes. However, the embodiments are not so limited. It is appreciated that the embodiments may be adapted for use in other applications which may be improved by the disclosed structures, arrangements and/or methods. The system is merely shown and described as being used in the context of creating pocket holes for ease of description and as one of countless examples.

### Pocket Hole Jig System Having Angled Stationary Upright

With reference to the figures, a pocket hole jig system having an angled stationary upright (or simply “system 10”) is presented. System 10 is formed of any suitable size, shape, and design and is configured to quickly, easily, and efficiently facilitate the clamping of workpieces of various types, shapes, and sizes. More specifically, system 10 is configured to clamp workpieces in order for pocket holes to be drilled into the workpiece. In the arrangement shown, as one example, system 10 has a forward end 12, a rearward end 14, opposing left and right sides 16 (or simply “sides 16”), a top side 18, and a bottom side 20. In the arrangement shown, as one example, system 10 includes a base 22, a clamp assembly 24, an upright assembly 26, and a drill guide assembly 28, among other components as is described herein. While system 10 has been described according to the arrangement shown, as one example, any combination or arrangement may be used and is hereby contemplated for use.

### Base 22

In the arrangement shown, as one example, system 10 includes base 22. Base 22 is formed of any suitable size, shape, and design and is configured to provide a generally planar work surface and connect to various components of system 10. In the arrangement shown, as one example, base 22 has a upper surface 30, a lower surface 32, a front wall 34, a back wall 36, and opposing sidewalls 38 (or simply “sidewalls 38”). In the arrangement shown, as one example, base 22 includes recessed openings 40, a dovetail feature 42, a step 46 leading to a recessed platform 48, and a base plate recess 50.

In the arrangement shown as one example, base 22 is formed of a single, unitary member that is formed in a manufacturing process such as injection molding, molding, machining, extrusion, forming, additive manufacturing, or the like to form a unitary and monolithic member. Alternatively, base 22 may be formed of multiple pieces that are connected or assembled to one another through adhesion, screwing, friction fitting, or any other means of connecting or assembling multiple pieces. In the arrangement shown, as one example, base 22 is formed primarily of a non-metallic material such as a plastic material, a fiberglass material, or any other non-metallic material and/or composite thereof. Alternatively, base 22 may be formed of a metallic material such as steel, aluminum, chromium, or any other metallic material, alloy, and/or composite thereof.

In the arrangement shown, as one example, when viewed from any of the forward end 12, rearward end 14, opposing sides 16, top side 18, or bottom side 20 base 22 is a generally rectangular member. In the arrangement shown, as one example, upper surface 30 extends in approximate parallel planar space relation to lower surface 32 and upper surface 30 and lower surface 32 extend in approximate perpendicular planar relation to front wall 34, back wall 36, and each of the sidewalls 38 of base 22. In the arrangement shown, as one example, upper surface 30 forms a generally planar work surface upon which a workpiece may rest while it is being drilled using system 10. In the arrangement shown, as one example, upper surface 30 extends a distance less than the distance between front wall 34 and back wall 36, however in alternative arrangements, as examples, upper surface 30 may extends a distance equal to or greater than the distance between front wall 34 and back wall 36.

In the arrangement shown, as one example, front wall 34 extends in approximate planar spaced relation to back wall 36 and front wall 34 and back wall 36 extend in approximate perpendicular planar relation to upper surface 30, lower surface 32, and each of the sidewalls 38 of base 22. In the arrangement shown, as one example, the sidewalls 38 of base 22 run in approximate parallel planar spaced relation to one another and in approximate perpendicular planar relation to upper surface 30, lower surface 32, front wall 34, and back wall 36 of base 22. In the arrangement shown, as one example, front wall 34, back wall 36, and sidewalls 38 all taper slightly inward as they move from the lower surface 32 to upper surface 30 in order to allow for easy removal of base 22 from a mold, however base 22 is not so limited and front wall 34, back wall 36, and sidewalls 38 may be formed with any degree of taper, or no taper at all.

In the arrangement shown, as one example, step 46 extends generally downward from upper surface 30 until it reaches recessed platform 48, thereby forming a “step” or transition between upper surface 30 and recessed platform 48. In the arrangement shown, as one example, recessed platform 48 extends in approximate parallel planar spaced relation to upper surface 30 and lower surface 32, and recessed platform 48 extends in approximate perpendicular planar relation to front wall 34, back wall 36, and each of the sidewalls 38.

Recessed Openings 40: In the arrangement shown, as one example, base 22 includes structural features connected to its lower surface 32 in order to improve the strength and rigidity of base 22. In addition, base 22 may be secured to a planar surface, such as a work bench or other substantially horizontal work surface. In the arrangement shown, as one example, base 22 includes a plurality of recessed openings 40 which are positioned along the edges of upper surface 30 and recessed platform 48, and partially formed into sidewalls 38. Recessed openings 40 are formed of any suitable size, shape, and design and are configured to allow screws, bolts, or other fasteners to be inserted in order to securely attach base 22 to a workbench or other horizontal work surface.

Dovetail Feature 42: In various arrangements, system 10 may include side supports in order to provide additional support to a workpiece which is being drilled into. In the arrangement shown, as one example, side supports may be removably and replaceably attached to base 22 through dovetail features 42. Dovetail features 42 are formed of any suitable size, shape, and design and are configured to receive a corresponding dovetail feature on such side supports. In the arrangement shown, as one example, dovetail features 42 have opposing edges that taper inwardly toward one another as they move from upper surface 30 to lower surface 32 and, in this way, dovetail features 42 serve to firmly and securely hold the side supports therein.

Recessed Platform 48: In the arrangement shown, as one example, base 22 includes step 44 which serves as a step or transition between upper surface 30 and recessed platform 48. Recessed platform 48 is formed of any suitable size, shape, and design and is configured to facilitate connection between base 22 and upright assembly 26. In the arrangement shown, as one example, upright assembly 26 includes a base plate 94 and, recessed platform 48 allows for the top surface of the top portion 100 of base plate 94 of the upright assembly 26 to be in approximate planar alignment of upper surface 30. That is due to recessed platform 48, when a workpiece is being worked and the user is using system 10, there will be little to no gap between any portion of the workpiece and the top surface of the top portion 100 of base plate 94 of the upright assembly 26 or between any portion of the workpiece and upper surface 30 of base 22.

In the arrangement shown, as one example, recessed platform 48 includes an edges 52 near each sidewall 38 which include cutouts 54. Edges 52 are formed of any suitable size, shape, and design and are configured to provide a surface against which the base plate 94 of upright assembly 26 can rest. In this way, edges 52 serve to help hold the base plate 94 of upright assembly 26 securely in place when it is connected to base 22. In the arrangement shown, as one example, edges 52 include cutouts 54 which allow for various features of the base plate 94 of upright assembly 26 to fit properly on recessed platform 48. In the arrangement shown, as one example, holes 56 are also included in recessed platform 48 in order to screw, bolt, or otherwise securely fasten the base plate 94 of upright assembly 26 to recessed platform 48 and facilitate secured connection of upright assembly 26 to base 22.

Baseplate Recess 50: In the arrangement shown, as one example, base 22 includes base plate recess 50. Baseplate recess 50 is formed of any suitable size, shape, and design and is configured to allow base plate 94 of workpiece support member 64 of clamp assembly 24 to move in a path relative to base 22. In the arrangement shown, as one example, base plate recess 50 is formed partially into upper surface 30 and partially into front wall 34 and extends a distance rearward from front wall 34. In the arrangement shown, as one example, when viewed from top side 18, base plate recess 50 is generally rectangular in shape. In the arrangement shown, as one example, base plate recess 50 extends a distance downward into the upper surface 30 of base 22. In the arrangement shown, as one example, base plate recess 50 is approximately the same shape as base plate 94 of workpiece support member 64 of clamp assembly 24. In the arrangement shown, base plate recess 50 has a width that is slightly larger than the width of base plate 94 of workpiece support member 64 of clamp assembly 24 and base plate recess 50 has a length that is greater than the length of base plate 94 of workpiece support member 64 of clamp assembly 24. In the arrangement shown, as one example, the depth of base plate 50 is slightly greater than the depth of base plate 94 of workpiece support member 64 of clamp assembly 24. In this way, with base plate recess 50 allows base plate 94 of workpiece support member 64 of clamp assembly 24 to slide freely along the length of base plate recess 50, which allows for use of clamp assembly 24 in order to help clamp a workpiece in place when using system 10.

While base 22 has been described according the arrangement shown, as one example, it will be understood by those skilled in the art that any other configuration, combination, or variation of base 22 and its components may be used in order to provide a generally planar work surface and connect to various components of system 10.

### Clamp Assembly 24

In the arrangement shown, as one example, system 10 includes a clamp assembly 24. Clamp assembly 24 is formed of any suitable size, shape, and design and are configured to help facilitate clamping of a workpiece. In the arrangement shown, as one example, clamp assembly 24 includes a handle portion 60, a rod 62, and a workpiece support member 64, among other components described herein. In the arrangement shown, as one example, handle portion 60 is positioned adjacent or near the back wall 36 of base 22 and the workpiece support member 64 is positioned adjacent or near the front wall 34 of base 22. In the arrangement shown, as one example, rod 62 operably connects at its first end 65 to handle portion 60 and at its second end 66 to workpiece support member 64.

Handle Portion 60: In the arrangement shown, as one example, clamp assembly 24 includes handle portion 60. Handle portion 60 is formed of any suitable size, shape, and design and is configured to allow a user to quickly and easily facilitate clamping of a workpiece. In the arrangement shown, as one example, handle portion 60 includes a handle 68 which is configured to be grasped and pushed on by a user in order to facilitate clamping (or unclamping) of a workpiece. In the arrangement shown, as one example, handle 68 is generally in the shape of an oval, with the exception of a flat portion 70 at one end of the handle 68. In the arrangement shown, as one example, handle 68 connects to a pair of arms 72 at flat portion 70.

In the arrangement shown as one example, handle portion 60 is formed of multiple pieces that are connected or assembled to one another through adhesion, friction fitting, bolting, screwing, welding, or the like. Alternatively, handle portion 60 may be formed of a single, unitary member that is formed in a manufacturing process such as machining, injection molding, casting, extrusion, forming, additive manufacturing, or the like to form a unitary and monolithic member. In the arrangement shown, as one example, various components of handle portion 60 are formed primarily of a metallic material such as steel, aluminum, chromium, or any other metallic material, alloy, and/or composite thereof, while other components of handle portion 60 are formed primarily of a non-metallic material such as a plastic material, a fiberglass material, or any other non-metallic material and/or composite thereof. In various alternative arrangements, the various components of handle portion 60 may be formed of either metallic or non-metallic materials, regardless of the material depicted or described herein.

Arms 72: In the arrangement shown, as one example, handle portion 60 includes a pair of arms 72. Arms 72 are formed of any suitable size, shape, and design and are configured to connect handle 68 to additional components of handle portion 60. In the arrangement shown, as one example, arms 72 connect to the flat portion 70 of handle 68 and extend outward a distance and then angle away from each other to form a Y-shape or V-shape. In the arrangement shown, as one example, arms 72 angle away from each other such that the distance between the interior surfaces of each arm 72 is sufficient to receive the first end 65 of rod 62 between arms 72. In the arrangement shown, as one example, arms 72 are pivotally connected to the first end 65 of rod 62 by way of first axle 74. First axle 74 is formed of any suitable size, shape, and design and is configured to connect arms 72 to the first end 65 of rod 62.

Pivoting Levers 76: In the arrangement shown, as one example, each arm 72 extends past first axle 74 in order to connect to one of the pivoting levers 76 at a first end 77 of pivoting levers 76. In the arrangement shown, as one example, arms 72 and pivoting levers 76 are connected at rotatable joint 78. In the arrangement shown, as one example, the pivoting levers 76 are connected to one another by torsion arm 80, which extends across the bottom edge of pivoting levers 76. In the arrangement shown, as one example, torsion arm 80 serves to improve the rigidity of the clamping motion by providing a stop feature which halts the movement of handle 68. More specifically, as handle 68 is pushed down, the ends of arms 72 connected to the flat portion 70 of handle 68 also move down while the ends of arms 72 connected to the first end 77 of pivoting levers 76 at rotatable joint 78 move upward and the first end 77 of pivoting levers 76 and rotatable joint 78 also move upward. In this arrangement, as the first end 77 of pivoting levers 76 connected move upward, torsion arm 80 also moves upward until it contacts rod 62, thereby causing the movement of torsion arm 80, as well as rotatable joint 78, pivoting levers 76, arms 72, and handle 68, to stop. Once each component of handle portion is stopped, clamping of the workpiece is finished. In the arrangement shown, as one example, pivoting levers 76 extend a length between first end 77 and second end 82. In the arrangement shown, as one example, pivoting levers 76 connect at their second end 82 to the first end 86 of rod housing 84.

Rod Housing 84: In the arrangement shown, as one example, handle portion 60 includes a rod housing 84. Rod housing 84 is formed of any suitable size, shape, and design and is configured to at least partially house rod 62 therein. In the arrangement shown, as one example, rod housing 84 extends a length between a first end 86 and a second end 88 and has a through hole 90 extending through the entire length of rod housing 84. Through hole 90 is formed of any size, shape, and design and is configured to allow rod 62 to pass through rod housing 84. In the arrangement shown, as one example, rod housing 84 also includes flanges 88 near its first end 86. Flanges 88 are formed of any suitable size, shape, and design and are configured to facilitate connection of rod housing 84 to base 22. In the arrangement shown, as one example, flanges 88 are configured to be positioned adjacent the exterior surface of the back wall 36 of base 22 and screws, bolts, or other fasteners can be used to securely connect flanges 88 (and rod housing 84) to base 22. However, it will be understood by those of skill in the art that rod housing 84 may be connected to various components and positions on base 22.

Rod 62: In the arrangement shown, as one example, clamp assembly 24 includes rod 62. Rod 62 is formed of any suitable size, shape, and design and is configured to connect handle portion 60 to workpiece support member 64 and help facilitate clamping of workpieces. In the arrangement shown, as one example, rod 62 is a cylindrical rod which extends from its first end 65 to its second end 66. In the arrangement shown, as one example, the first end 65 of rod 62 connected to handle portion 60 of clamp assembly 24 through rod housing 84 and first axle 74.

In the arrangement shown, as one example, rod 62 has a hollow portion 92, which extends along the entire length of rod 62. In various alternative arrangements, rod 62 may not include hollow portion 92 at all, or hollow portion 92 may only extend a certain length through rod 62. In the arrangement shown, as one example, rod 62 is threaded at its second end 66 on either its exterior surface or, if a hollow portion 92 is present at second end 66, its interior surface. In the arrangement shown, as one example, rod 62 includes a hollow portion 92 at second end 66 and the interior of rod 62 at second end 66 is threated. In the arrangement shown, as one example, the workpiece support member 64 of clamp assembly 24 is connected to the second end 66 of rod 62 by threading (or otherwise connecting) fastener 106 of workpiece support member 64 into the hollow portion 92 of second end 66 of rod 62. In the arrangement shown, as one example, when fastener 106 is connected to the workpiece support member 64 and treaded into (or otherwise connected to) the second end 66 of rod 62, the workpiece support member 64 is operably connected to rod 62 and is thereby also connected to handle portion 60.

Workpiece Support Member 64: In the arrangement shown, as one example, clamp assembly 24 includes workpiece support member 64. Workpiece support member 64 is formed of any suitable size, shape, and design and is configured to support a workpiece and help facilitate clamping of the workpiece. In the arrangement shown, as one example, workpiece support member 64 includes a base plate 94, a body 96, and a clamping face 98.

In the arrangement shown as one example, workpiece support member 64 is formed of multiple pieces that are connected or assembled to one another through adhesion, friction fitting, bolting, screwing, welding, or the like. Alternatively, workpiece support member 64 may be formed of a single, unitary member that is formed in a manufacturing process such as machining, injection molding, casting, extrusion, forming, additive manufacturing, or the like to form a unitary and monolithic member. In the arrangement shown, as one example, workpiece support member 64 is formed primarily of a non-metallic material such as a plastic material, a fiberglass material, or any other non-metallic material and/or composite thereof. Alternatively, workpiece support member 64 may be formed of a metallic material such as steel, aluminum, chromium, or any other metallic material, alloy, and/or composite thereof.

In the arrangement shown as one example, workpiece support member 64 includes a base plate 94. Base plate 94 is formed of any suitable size, shape, and design and is configured to support the body 96 of workpiece support member 64. In the arrangement shown, as one example, base plate 94 has a top portion 100 and a flange 102. In the arrangement shown, as one example, top portion 100 is a generally planar member with a generally flat top surface upon which a portion of the body 96 rests. In the arrangement shown, as one example, flange 102 extends downward from the top portion 100 and includes a through hole 104, which allows fastener 106 to extend through flange 102 in order to be threated into (or otherwise connected to) the second end 66 of rod 62. In this way, flange 102 helps facilitate the connection of workpiece support member 64 to rod 62.

In the arrangement shown, as one example, when a user performs a clamping operation, the workpiece support member 64 will move in a path between a fully disengaged position and a fully clamped position. In the arrangement shown, as one example, the distance between the fully disengaged position and the fully clamped position is fixed or, said another way, the distance between the fully disengaged position and the fully clamped position is not adjustable based on the workpiece thickness. In the arrangement shown, as one example, the path the workpiece support member 64 travels is generally parallel to the upper surface 30 of base 22. In the arrangement shown, as one example, the base plate 94 of workpiece support member 64 of clamping assembly 24 is also vertically located such that the top surface of the top portion 100 of base plate 94 is approximately co-planar with the upper surface 30 of base 22. In order to facilitate the moving of workpiece support member 64 during the clamping operation, base plate recess 50 is included in base 22 as described herein. With base plate recess 50 included in base 22, base plate 94 of workpiece support member 64 of clamping assembly 24 may move in a direction approximately parallel to the upper surface 30 of base 22 while the top surface of top portion 100 of base plate 94 is also approximately co-linear with upper surface 30.

In the arrangement shown, as one example, the at least a portion of the body 96 of workpiece support member 64 rests on the top surface of the top portion 100 of base plate 94. The body 96 of workpiece support member 64 may be formed of any size, shape, and design and is configured to help facilitate the support and clamping of a workpiece. In the arrangement shown, as one example, the body 96 of workpiece support member 64 is a generally curved member which starts at a first end which is connected to the top surface of the top portion 100 of base plate 94. In the arrangement shown, as one example, the body 96 then extends upward and, as it extends upward, it slightly curves toward handle portion 60, however in various other arrangements the body 96 of workpiece support member 64 may curve in any other direction, or have no curve at all, and still function to help facilitate support and clamping of a workpiece. In the arrangement shown, as one example, body 96 curves until it reaches clamping face 98, which is a generally flat and planar surface formed of, or connected to, the second end of body 96. In the arrangement shown, as one example, body 96 curves approximately 90 degrees such that the clamping face 98 is approximately perpendicular to the first end of body 96 and the top surface of the top portion 100 of base plate 94. In the arrangement shown, as one example, clamping face 98 is approximately parallel to a surface which the clamping face 98 will contact when system 10 is used to clamp a workpiece in place.

While clamping assembly 24 and its various components have been described according the arrangement shown, as one example, it will be understood by those skilled in the art that any other configuration, combination, or variation of clamping assembly 24 and its components may be used in order to help facilitate clamping of a workpiece.

In the arrangement shown, as one example, when a workpiece is clamped into system 10, it is positioned between the clamping face 98 of workpiece support member 64 of clamping assembly 24 and the clamping face 154 of drill guide block 136 of drill guide assembly 28. In the arrangement shown, as one example, drill guide assembly 28 is configured to move along upright assembly 26.

### Upright Assembly 26

In the arrangement shown, as one example, system 10 includes upright assembly 26. Upright assembly 26 is formed of any suitable size, shape, and design and is configured to support drill guide assembly 28. In the arrangement shown, as one example, upright assembly 26 also provides a path along which drill guide assembly 28 travels. In the arrangement shown, as one example, upright assembly 26 includes a base plate 110, a rear support member 112, side support members 114, a forward member 116, and a guide 118.

In the arrangement shown as one example, upright assembly 26 is formed of a single, unitary member that is formed in a manufacturing process such as injection molding, casting, machining, extrusion, forming, additive manufacturing, or the like to form a unitary and monolithic member. Alternatively, upright assembly 26 may be formed of multiple pieces that are connected or assembled to one another through bolting, however any other means of connecting or assembling the multiple pieces may be used, including adhesion, screwing, welding, friction fitting, or the like. In the arrangement shown, as one example, upright assembly 26 is formed primarily of a non-metallic material such as a plastic material, a fiberglass material, or any other non-metallic material and/or composite thereof. Alternatively, upright assembly 26 may be formed of a metallic material such as steel, aluminum, chromium, or any other metallic material, alloy, and/or composite thereof.

In the arrangement shown, as one example, upright assembly 26 is a stationary member which is configured to be attached to base 22. In the arrangement shown, as one example, when viewed from either opposing side 16 of system 10, upright assembly 26 is generally in the shape of a triangle. That is, when viewed from a side 16, upright assembly has a bottom surface, formed by base plate 110, a rear surface which may be vertically straight up and down or which angles slightly toward the forward end 12 of system 10 as it moves up from the bottom surface, and a forward surface, formed by forward member 116, which is angles toward the rearward end 14 of system 10 as it moves up from the bottom surface. In this way, upright assembly 26 creates an angled surface at its forward end. This angled surface at the forward end of upright assembly 26 is important because drill guide assembly 28 must be placed accurately in order to create appropriate pocket holes in workpieces of various thicknesses. The angled surface of upright assembly 26 allows for drill guide assembly 28 to be moved rearward and upward, or forward and downward, and be stopped at various positions which correspond to different workpiece thicknesses. That is, the angled surface, which is created by forward member 116, helps facilitate the proper placement of drill guide assembly 28 in order to accommodate for workpieces of varying thicknesses and drill appropriate pocket holes for the varying workpieces.

Base Plate 110: In the arrangement shown, as one example, upright assembly 26 includes base plate 110. Base plate 110 is formed of any suitable size, shape, and design and is configured to help facilitate connection of upright assembly 26 to base 22. In the arrangement shown, as one example, base plate 110 is a generally planar member and generally forms a rectangle. In the arrangement shown, as one example, base plate 110 includes openings 120 configured to receive screws, bolts, or a similar fastener in order to connect base plate 110, and upright assembly 26, to base 22. In the arrangement shown, as one example, base plate 110 is connected to recessed platform 48 of base 22 and base plate 110 contacts the edges 52 of recessed platform 48 such that base plate 110 fits within close and tight tolerances on recessed platform 48.

Support Members: In the arrangement shown, as one example, the rear support member 112 and side support members 114 extend upward from base plate 110. Rear support member 112 and side support members 114 are formed of any suitable size, shape, and design and are configured to help support forward member 116 of upright assembly 26. In the arrangement shown, as one example, rear support member 112 is a generally rectangular planar member which extends upward from base plate 110 vertically or at a slight angle toward the forward end 12 of system 10 as it moves extends upward. In the arrangement shown, as one example, side support members 114 are generally triangular planar members which extend upward from base plate 110 with a forward side that angles toward the rearward end 14 of system 10 as it extends upward, a rearward side that angles toward the forward end 112 of system 10 as it extends upward, and a bottom member which extends horizontally and connects to base plate 110. Each of the rear support member 112 and side support members 114 extend upward until they meet and connect to forward member 116.

Forward Member 116: In the arrangement shown, as one example, upright assembly 26 includes forward member 116. Forward member 116 is formed of any suitable size, shape, and design and is configured to help facilitate the proper positioning of drill guide assembly 28 to accommodate for workpieces of varying thicknesses. In the arrangement shown, as one example, forward member 116 is a generally rectangular planar member which extends upward a distance from base plate 110 and meets the upper edges of side support members 114. In the arrangement shown, as one example, forward member 116 also includes exit holes 122 which are configured to allow material removed from the workpiece during a drilling operation to be removed from the work area. In the arrangement shown, as one example, guide 118 of upright assembly 26 extend upward and outward from forward member 116 towards the forward end 12 of system 10 near the sides of forward member 116.

Guide 118: In the arrangement shown, as one example, upright assembly 26 includes guide 118. Guide 118 is formed of any suitable size, shape, and design and is configured to engage drill guide assembly 28 and provide a path along which drill guide assembly 28 is able to slide. In the arrangement shown, as one example, guide 118 is formed of rails or similar members which extend upward and outward from either side of forward member 116. In the arrangement shown, as one example, the outer edge 124 of guide 118 is approximately parallel to forward member 116 or, said another way, the angle of guide 118 as it extends upward is the same angle at which forward member 116 extends upward from base plate 110. In the arrangement shown, as one example, drill guide assembly 28 engages with guide 118 and slides along guide 118 in order to accommodate for workpieces of varying thicknesses.

In the arrangement shown, as one example, guide 118 includes a plurality of recesses 126 which correspond to popular workpiece thicknesses. That is, when a user is moving drill guide assembly 28 along guide 118, drill guide assembly 28 may stop at one of the plurality of recesses 126 which corresponds to a popular workpiece thickness. In the arrangement shown, as one example, there are three recesses 126 and the recesses may correspond to workpiece thicknesses of one and one-half inches (1.5″), one inch (1″), and three-quarter inch (0.75″). In various other arrangements, any other number of recesses 126 may be provided and such recesses 126 may correspond to any other workpiece thicknesses, such as one-half inch (0.5″), two inches (2″), or any other thickness. In the arrangement shown, as one example, guide 118 includes a stop member 128 configured to prevent drill guide assembly 28 from sliding past a certain point along guide 118.

While upright assembly 26 and its components have been described according the arrangement shown, as one example, it will be understood by those skilled in the art that any other configuration, combination, or variation of upright assembly 26 and its components may be used in order to support drill guide assembly 28 and provide a path along which drill guide assembly 28 can travel.

### Drill Guide Assembly 28

In the arrangement shown, as one example, system 10 includes drill guide assembly 28. Drill guide assembly 28 is formed of any suitable size, shape, and design and is configured to connect to and slide along guide 118 of upright assembly 26, help facilitate the clamping of workpieces, and help facilitate accurate drilling of a pocket hole in a workpiece. In the arrangement shown, as one example, drill guide assembly 28 includes a body 134 and a drill guide block 136.

In the arrangement shown, as one example, drill guide assembly moves along a path formed by guide 118 of upright assembly 26. In the arrangement shown, as one example, the adjustment of drill guide assembly 28 accounts for variations in workpiece thicknesses. That is, in the arrangement shown as one example, when a workpiece that is relatively thin must be clamped, drill guide assembly 28 is moved downward and forward along guide 118 of upright assembly 26, thereby reducing the space between the clamping face 154 of drill guide block 136 and clamping face 98 of workpiece support member 64 of clamping assembly 24. Conversely, when a workpiece that is relatively thick must be clamped, drill guide assembly 28 is moved upward and rearward along guide 118 of upright assembly 26, thereby increasing the space between the clamping face 154 of drill guide block 136 and clamping face 98 of workpiece support member 64 of clamping assembly 24. The adjustment of drill guide assembly 28 is important because the path workpiece support member 64 of clamping assembly 24 travels is fixed and cannot be adjusted, therefore it is necessary to allow for adjustment of the position of drill guide assembly 28 to account for various workpiece thicknesses.

In the arrangement shown as one example, drill guide assembly 28 is formed of multiple pieces that are connected or assembled to one another through friction fitting, adhesion, bolting, screwing, welding, or the like. Alternatively, drill guide assembly 28 may be formed of a single, unitary member that is formed in a manufacturing process such as injection molding, molding, machining, extrusion, forming, additive manufacturing, or the like to form a unitary and monolithic member. In the arrangement shown, as one example, drill guide assembly 28 is formed primarily of a non-metallic material such as a plastic material, a fiberglass material, or any other non-metallic material and/or composite thereof. Alternatively, drill guide assembly 28 may be formed of a metallic material such as steel, aluminum, chromium, or any other metallic material, alloy, and/or composite thereof.

Body 134: In the arrangement shown, as one example, drill guide assembly 28 includes a body 134. Body 134 is formed of any suitable size, shape, and design and is configured to connect to upright assembly 26 and support drill guide block 136. In the arrangement shown, as one example, body 134 includes a top surface 138, side surfaces 140, and angled surface 142, and engagement members 144.

In the arrangement shown, as one example, when viewed from a side 16 of system 10, drill guide assembly 28, including body 134, is a generally triangular shaped member, with a forward end that is generally planar and vertical and which forms the clamping face 154 of drill guide block 136, a top end that angles slightly downward as it extends rearward and which forms the top surface 138 of the body 134, and a rear side that angles generally forward as it extends downward and forms the angled surface 142 of the body 134.

In the arrangement shown, as one example, body 134 includes side surfaces 140. Side surfaces 140 are formed of any suitable size, shape, and design and are configured to facilitate connection between body 134 and drill guide block 136. In the arrangement shown, as one example, side surfaces 140 are generally planar surfaces which extend downward from top surface 138 on both sides of body 134. In the arrangement shown, as one example, side surfaces 140 also include arms 146. Arms 146 are formed of any suitable size, shape, and design and are configured to extend outward from body 134 and engage and hold drill guide assembly 28 in connection with body 134.

In the arrangement shown, as one example, body 134 includes angled surface 142. Angled surface 142 is formed of any suitable size, shape, and design and is configured to facilitate smooth movement of body 134 and drill guide assembly 28 along guide 118 of upright assembly 26. In the arrangement shown, as one example, angled surface 142 of the body 134 extends in approximate parallel planar faction to forward member 116 and guide 118. That is, in the arrangement shown as one example, the angle at which angled surface 142 extends as it moves upward and rearward is approximately the same as the angle at which forward member 116 and guide 118 of upright assembly 26 extend upward and rearward. This arrangement of angled surface 142 of drill guide assembly 28 and forward member 116 and guide 118 of upright assembly 26 facilitate easy and smooth movement of drill guide assembly 28 along guide 118 and upright assembly 26.

In the arrangement shown, as one example, body 134 also includes engagement members 144. Engagement members 144 are formed of any suitable size, shape, and design and are configured to engage with guide 118 of upright assembly 26. In the arrangement shown, as one example, engagement members 144 include a flexible portion 148 which is configured to allow engagement members 144 to move inward to disengage from the recesses 126 of guide 118 in order to move drill guide assembly 28 along guide 118. In the arrangement shown, as one example, flexible portion 148 is connected at one end to the side surfaces 140 of body 134 and are free at their other end, allowing the other end to be compressed or pushed inward. In the arrangement shown, as one example, engagement members 144 also include grip members 150 which provide a contact point for users to push in, thereby causing the flexible portion 148 to disengage from the recesses 126. In the arrangement shown, as one example, grip members 150 are generally rectangular members that extend outward from the free end of the flexible portion 148. In the arrangement shown, as one example, engagement members 144 include protrusions 152 which are located adjacent the grip members 150. In the arrangement shown, as one example, protrusions 152 are generally sized and shaped to fit within the recesses 126 of guide 118. That is, when drill guide assembly 28 is slid along guide 118 to a position which corresponds to typical workpiece thicknesses, protrusions 152 will be generally aligned with recesses 126 and will rest within recesses 126, thereby locking drill guide assembly 28 into place at that position on guide 118 until a user desires to move drill guide assembly 28 again.

In the arrangement shown, as one example, the body 134 of drill guide assembly 28 is configured to engage with and hold drill guide block 136.

Drill Guide Block 136: In the arrangement shown, as one example, drill guide assembly 28 includes a drill guide block 136. Drill guide block 136 is formed of any suitable size, shape, and design and is configured to help facilitate clamping of workpieces and help facilitate the drilling of pocket hole jigs. In the arrangement shown, as one example, drill guide block 136 is a generally rectangular member which has a clamping face 154, guide channels 156, and bore openings 158.

In the arrangement shown, as one example, the surface of drill guide block 136 which is closest to forward end 12 of system 10 is clamping face 154. Clamping face 154 is formed of any suitable size, shape, and design and is configured to help facilitate clamping of workpieces and the drilling of pocket holes in workpieces. In the arrangement shown, as one example, clamping face 154 is a generally flat and planar, vertically extending surface which extends a height from the bottom to the top of drill guide block 136. In the arrangement shown, as one example, clamping face 154 is generally straight up and down vertically, and is in approximate parallel planar spaced alignment with the clamping face 98 of workpiece support member 64 of clamping assembly 24.

In the arrangement shown, as one example, drill guide block 136 also includes guide channels 156 and bore openings 158. Guide channels 156 are formed of any suitable size, shape, and design and are configured to help facilitate the drilling of pocket holes in a workpiece. In the arrangement shown, as one example, guide channels 156 are holes which extend through the top surface of drill guide block 136 at an angle appropriate for pocket holes and guide channels 156 exit drill guide block 136 through the clamping face 154 at bore openings 158. In this way, a drill bit can be inserted into the guide channels 156 of drill guide block 136, extend through the guide channels 156 and out bore openings 158. In the arrangement shown, as one example, when a workpiece is clamped between the clamping face 154 of drill guide assembly 28 and clamping face 98 of workpiece support member 64 and a drill bit is extended out bore openings 158, the drill bit will enter into the workpiece and can be used to create a pocket hole in the workpiece.

While drill guide assembly 28 and its components have been described according the arrangement shown, as one example, it will be understood by those skilled in the art that any other configuration, combination, or variation of drill guide assembly 28 and its components may be used in order to connect to and slide along guide 118 of upright assembly 26 and help facilitate accurate drilling of a pocket hole in a workpiece.

### In Operation

System 10 may be utilized to drill pocket holes in a workpiece. In the arrangement shown, as one example, a user will pick out a desired workpiece with a certain thickness. Prior to clamping the workpiece using system 10, the user can adjust the drill guide assembly 28 by moving it along guide 118. The user can push on the grip member 150 of engagement members 144 of body 134 of drill guide assembly 28, thereby causing the flexible portion 148 of engagement members 144 to compress, causing protrusions 152 of engagement members 144 to disengage from recesses 126 of guide 118. Once protrusions 152 are disengaged from recesses 126, the user is free to move drill guide assembly 28 upward and rearward along guide 118 (to accommodate for workpieces of greater thickness) or downward and forward along guide 118 (to accommodate for workpieces of lesser thickness). Once drill guide assembly 28 is at the desired position corresponding to the selected workpiece thickness, the user will release grip member 150, thereby causing flexible portion 148 to return to its natural resting position, causing protrusions 152 to engage the recesses 126 of guide 118 corresponding to the workpiece thickness.

Once the drill guide assembly 28 is in the desired position, the user can position the workpiece between the clamping face 154 of drill guide block 136 of drill guide assembly 28 and clamping face 98 of workpiece support member 64 of clamping assembly 24. The user will then move handle 68 of handle portion 60 of clamp assembly 24 downward. As handle 68 of handle portion 60 is moved downward, the arms 72 of handle portion are moved, causing the first axle 74 of handle portion 60 to move rearward. As the first axle 74 of handle portion 60 moves rearward, rod 62 of clamp assembly 24 is forced to move rearward, which in turn forces workpiece support member 64 to move rearward and into a fully clamped position. With the workpiece support member 64 in the fully clamped position, the workpiece will be clamped within close and tight tolerances between clamping face 154 of drill guide block 136 of drill guide assembly 28 and clamping face 98 of workpiece support member 64 of clamping assembly 24.

Once the workpiece is properly clamped, the user can then use a drill and stepped drill bit to form a pocket hold in the workpiece. The user can insert the drill bit into and through the guide channels 156 of drill guide block 136 of drill guide assembly 28. Once the drill bit is extended through the guide channels 156, it will exit the guide channels 156 through bore openings 158. The user will then insert the drill bit into the workpiece a desired distance to form the pocket hole.

### Alternative Arrangement

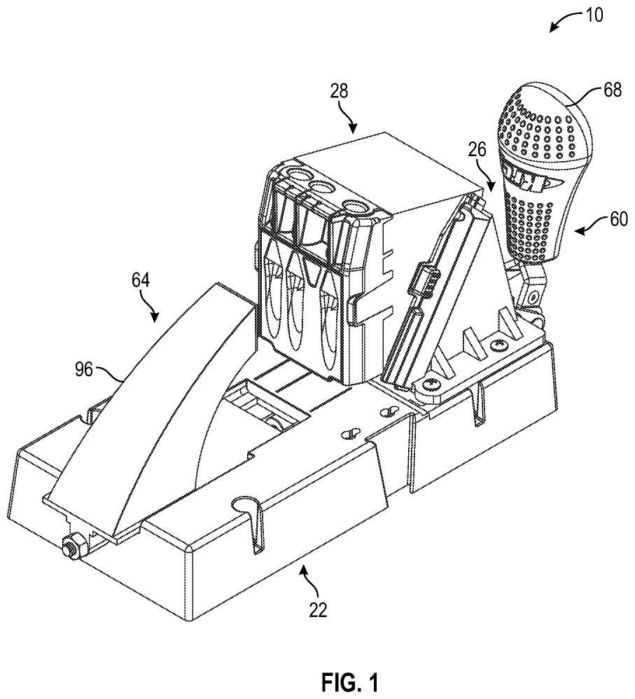

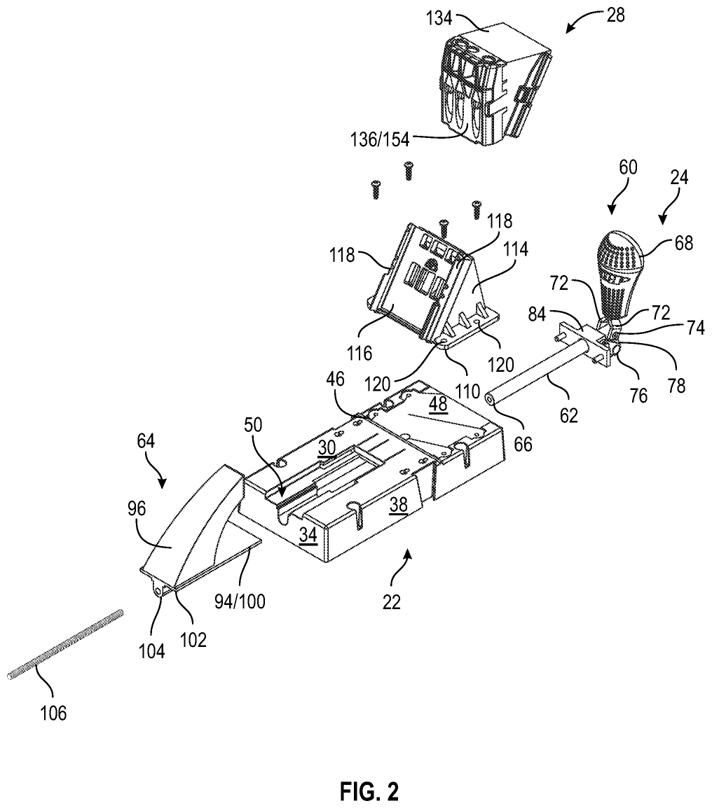

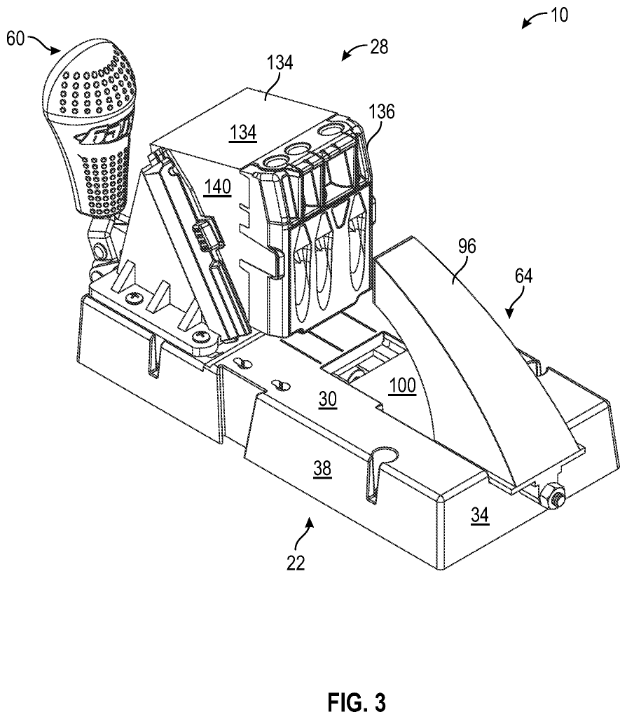

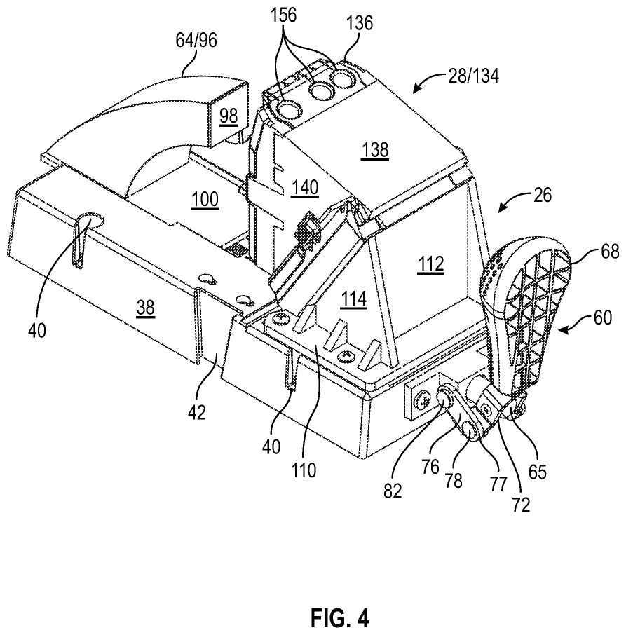

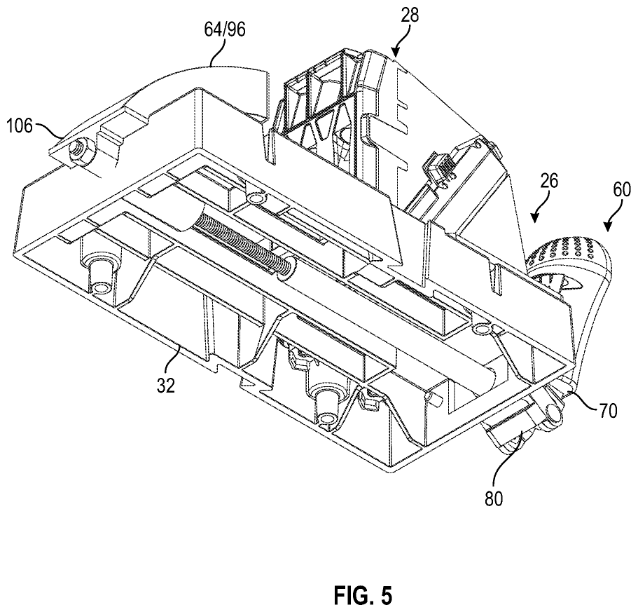

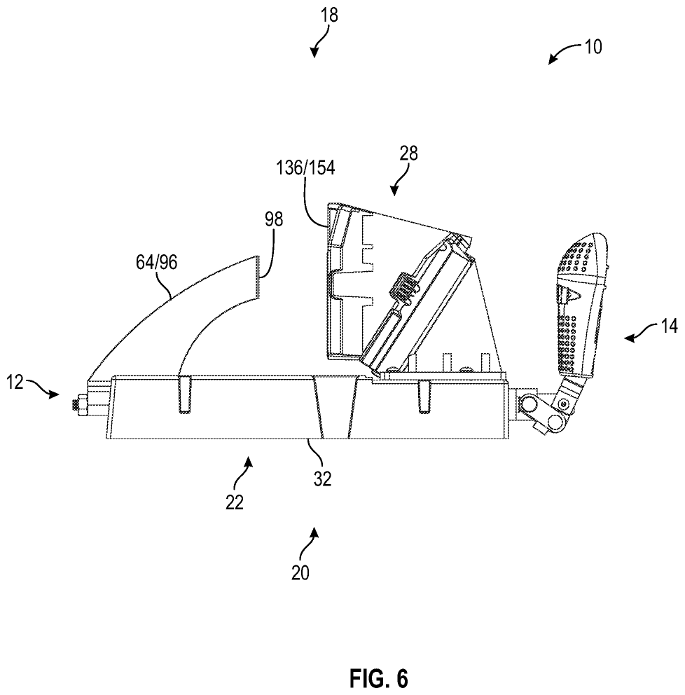

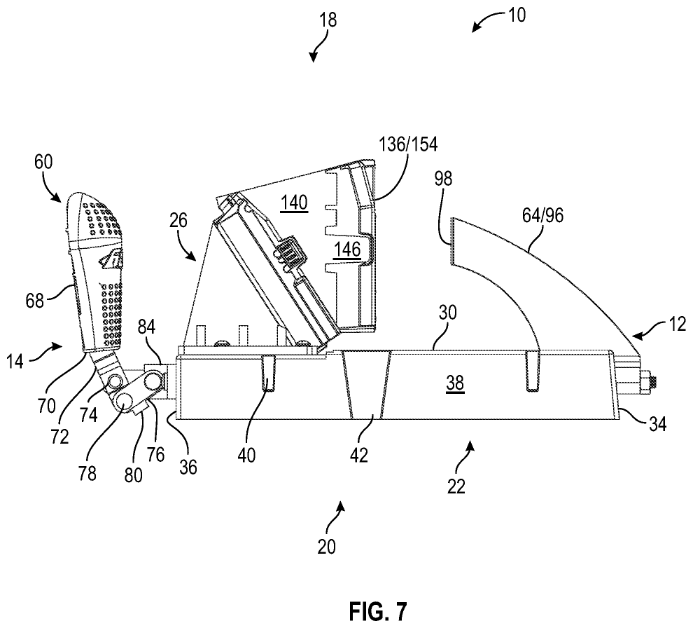

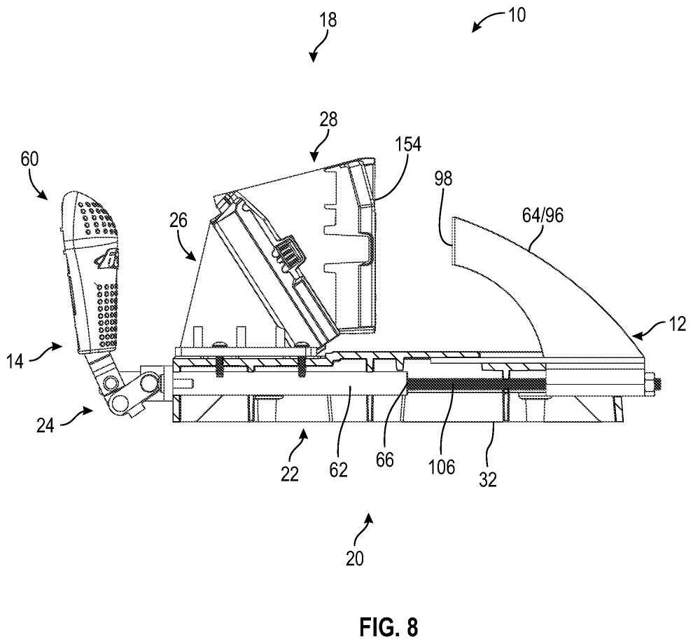

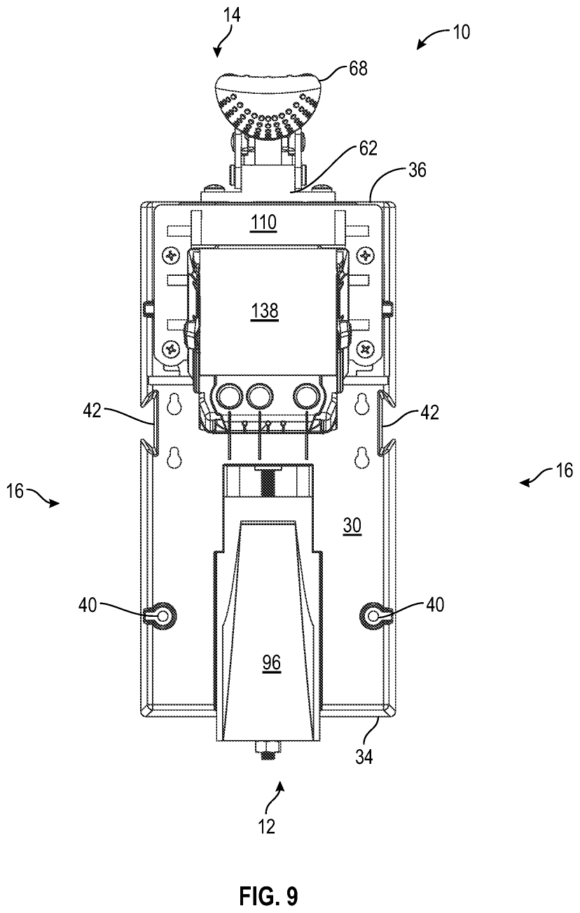

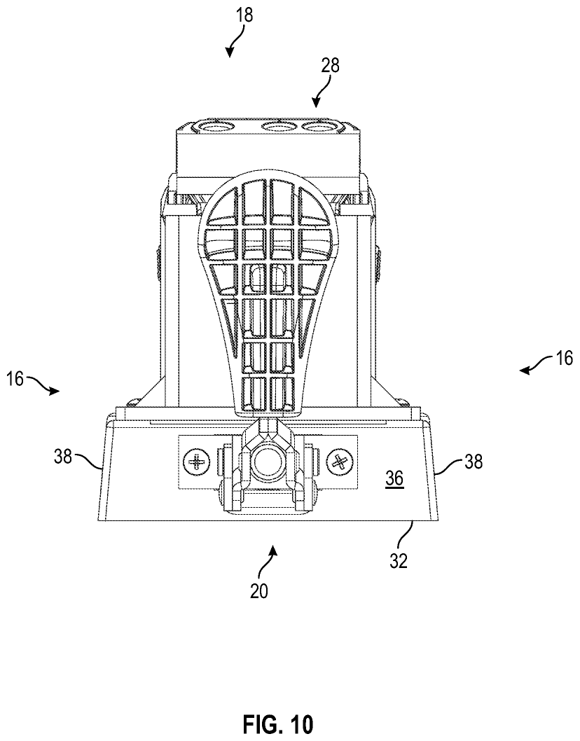

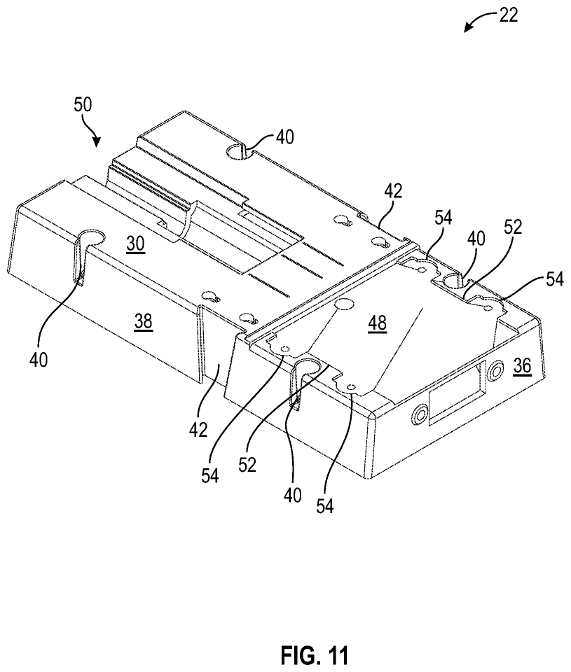

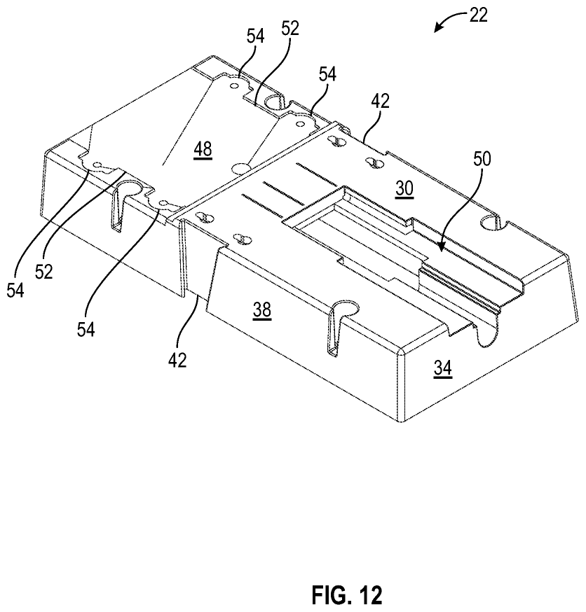

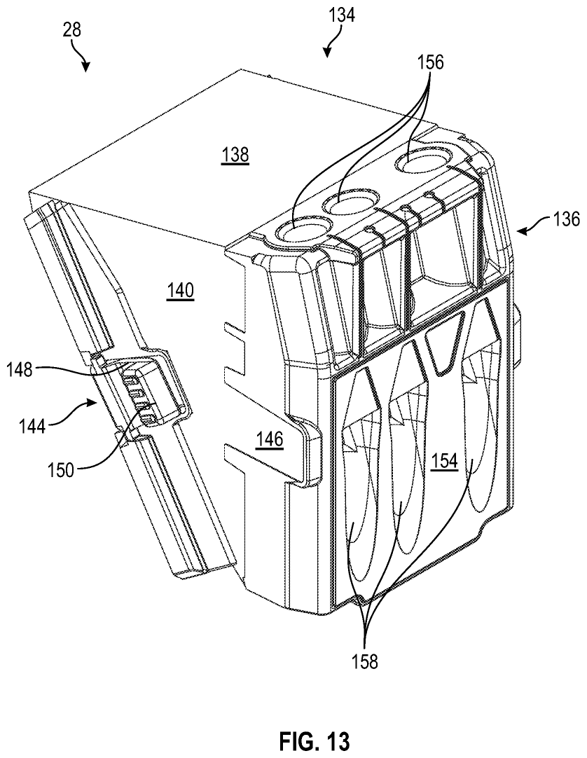

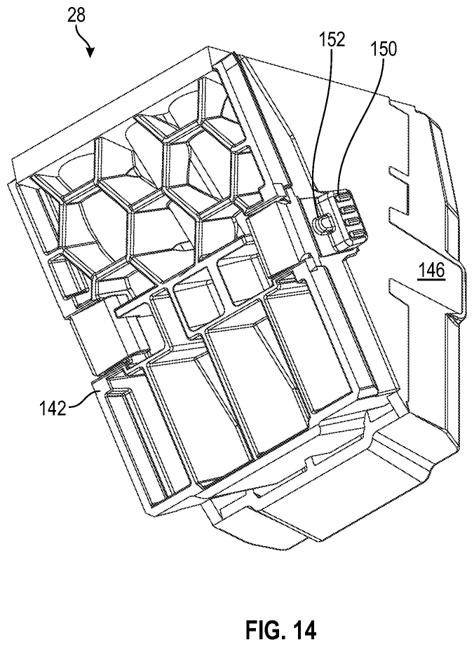

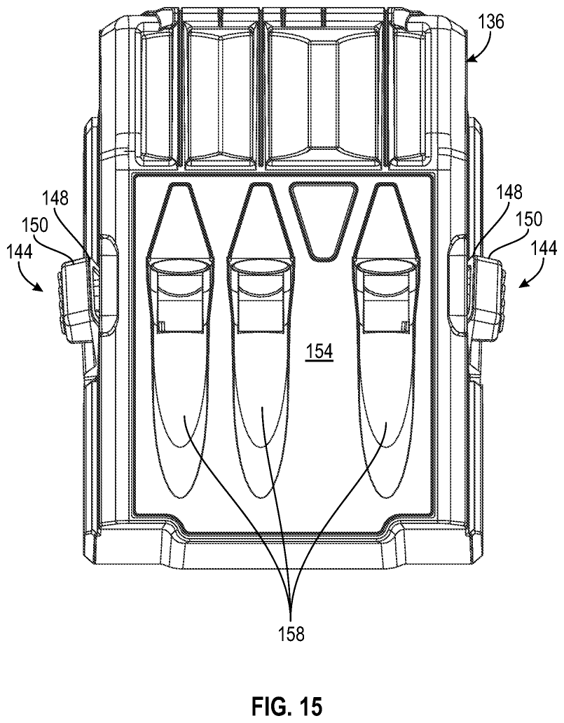

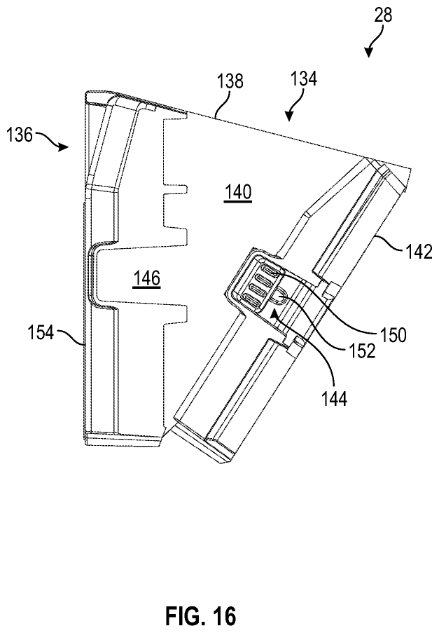

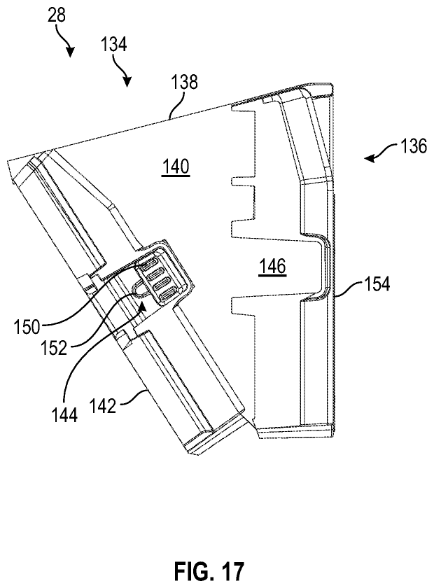

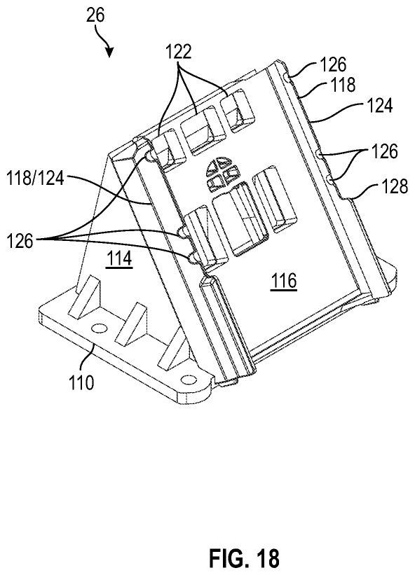

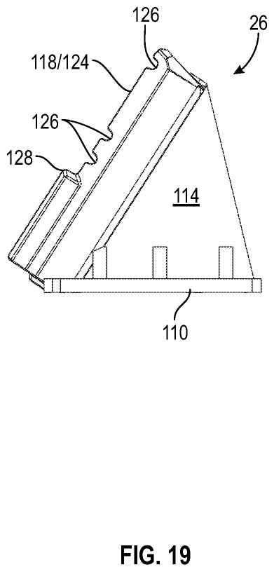

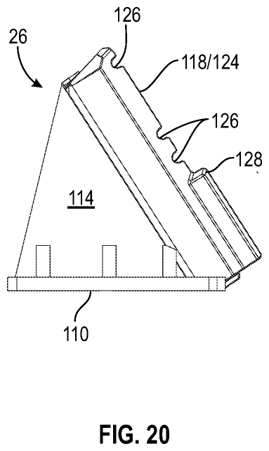

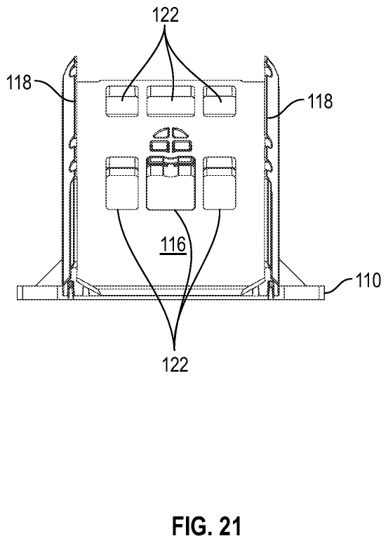

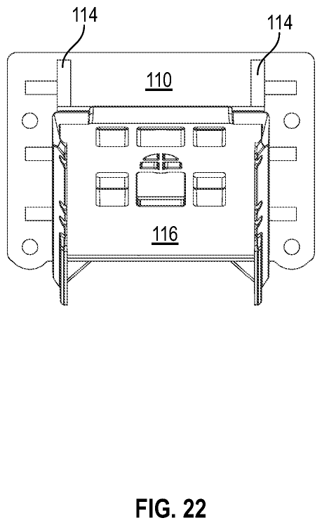

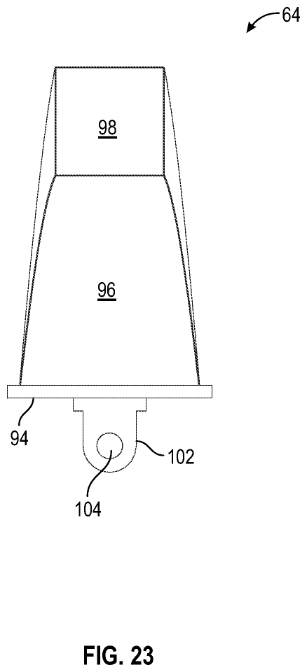

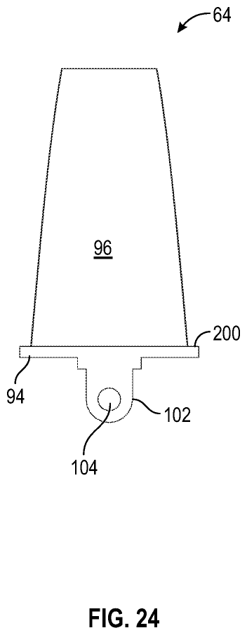

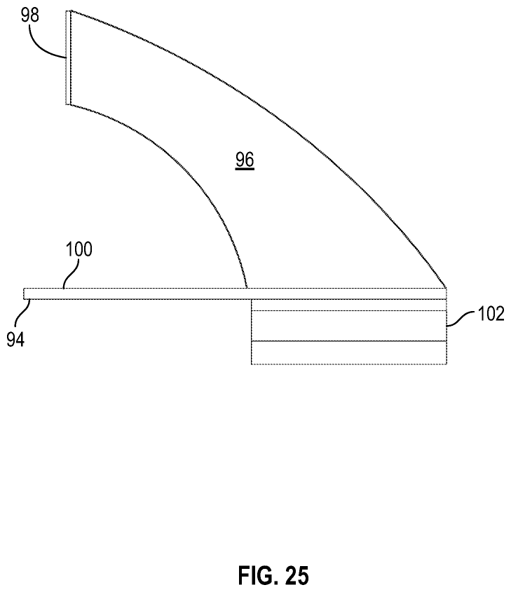

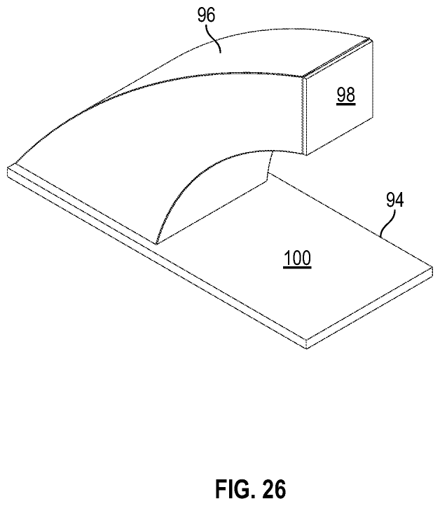

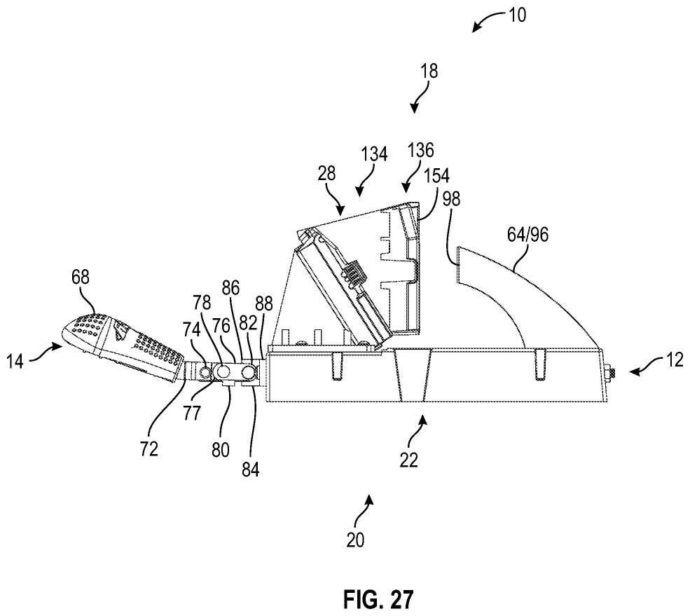

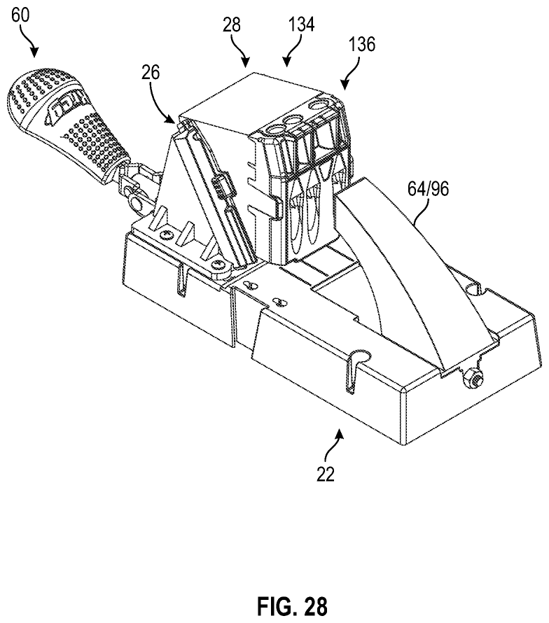

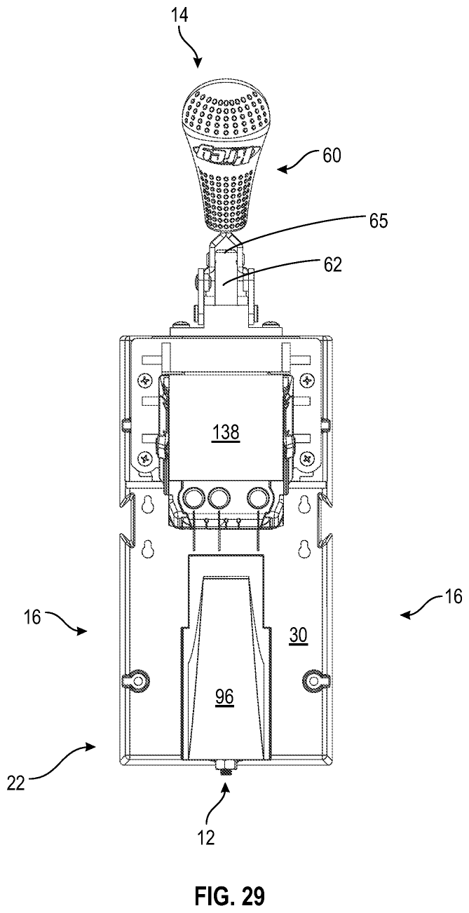

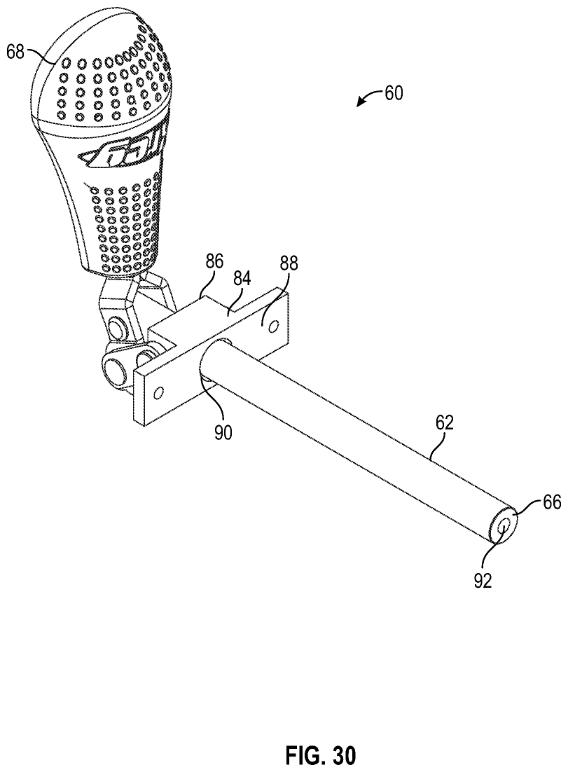

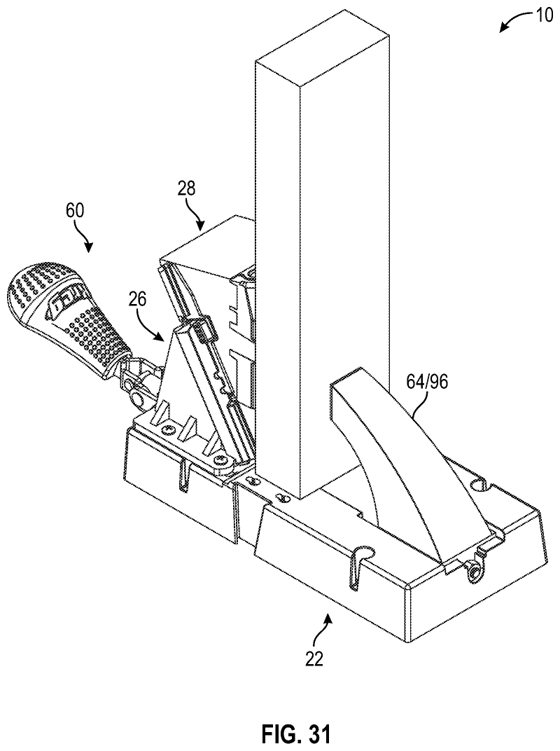

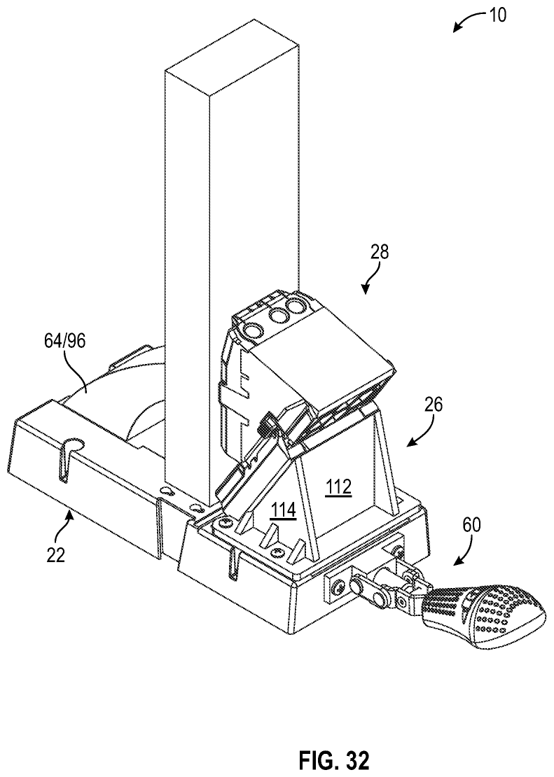

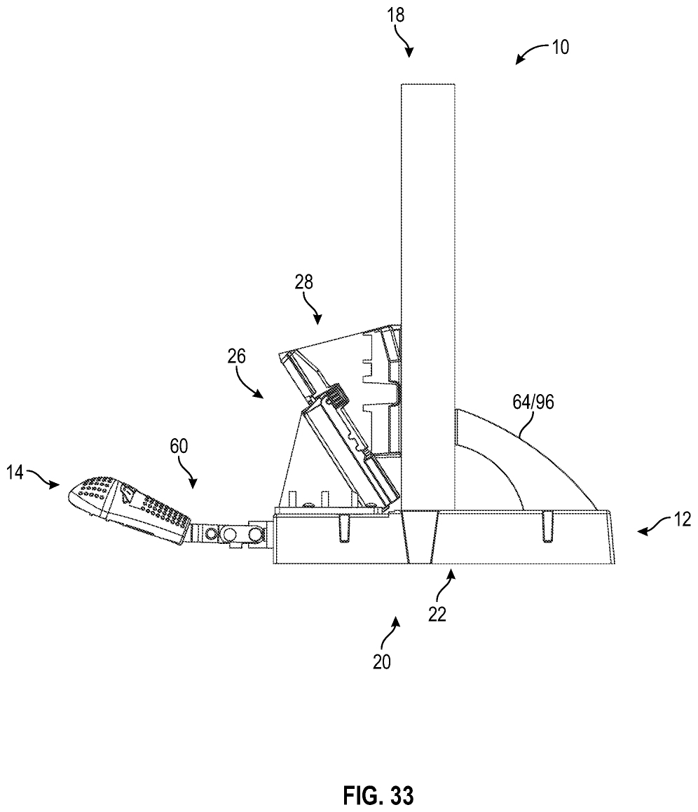

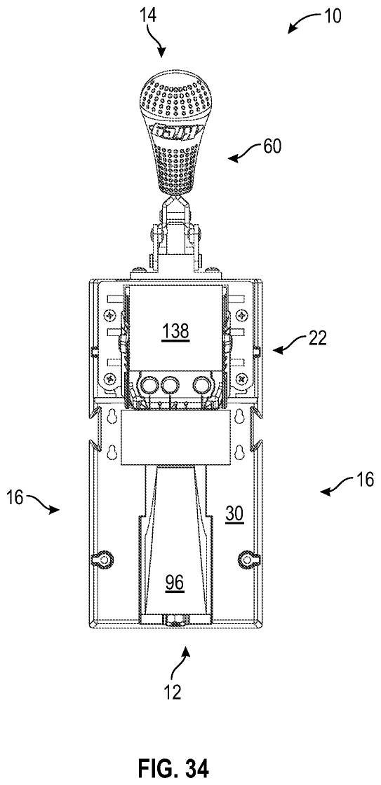

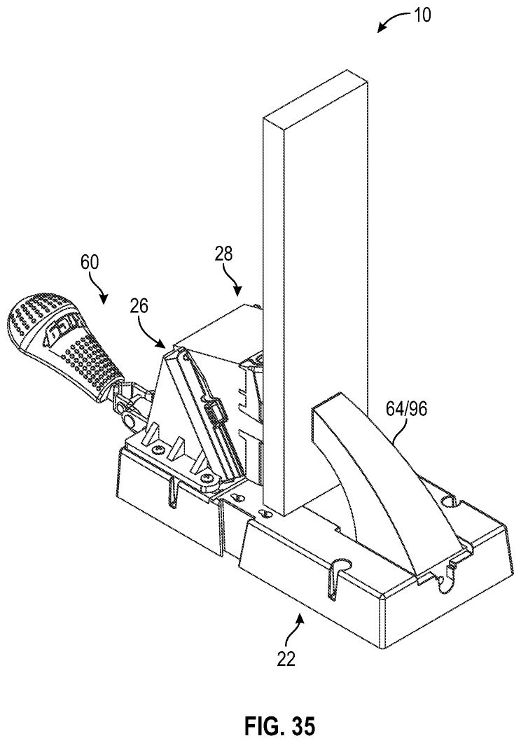

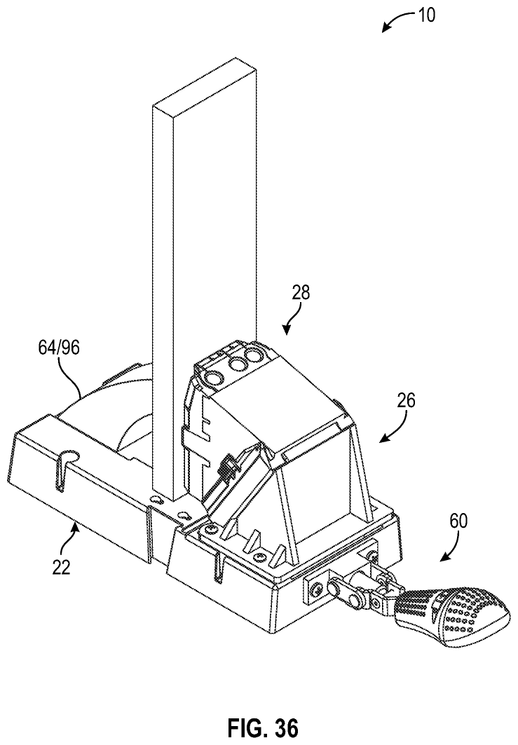

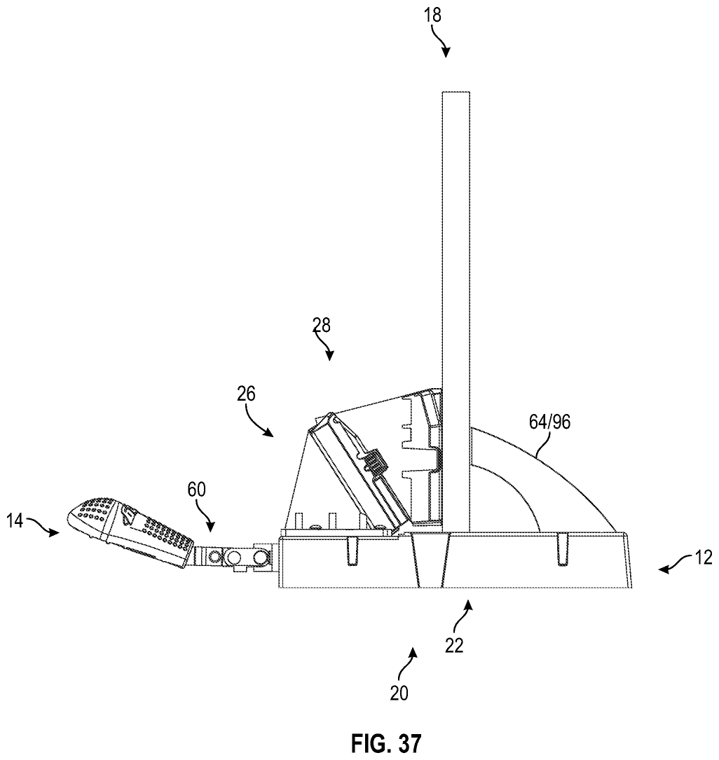

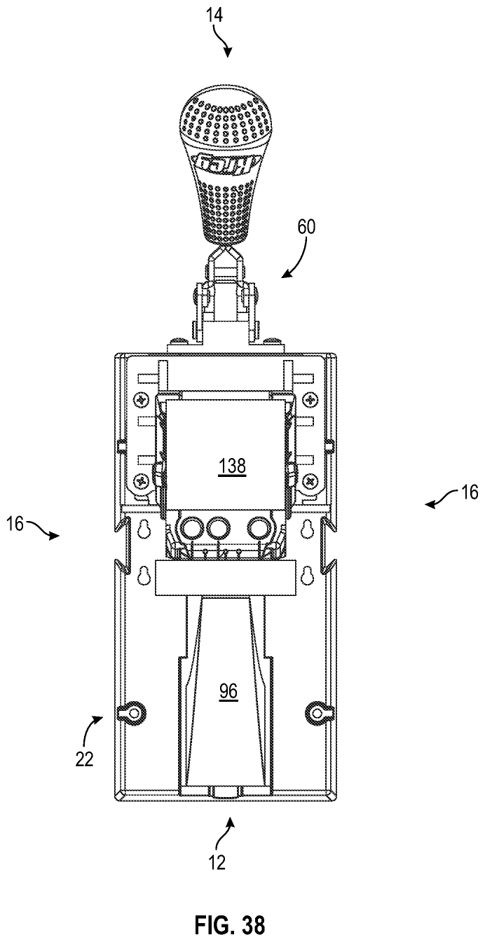

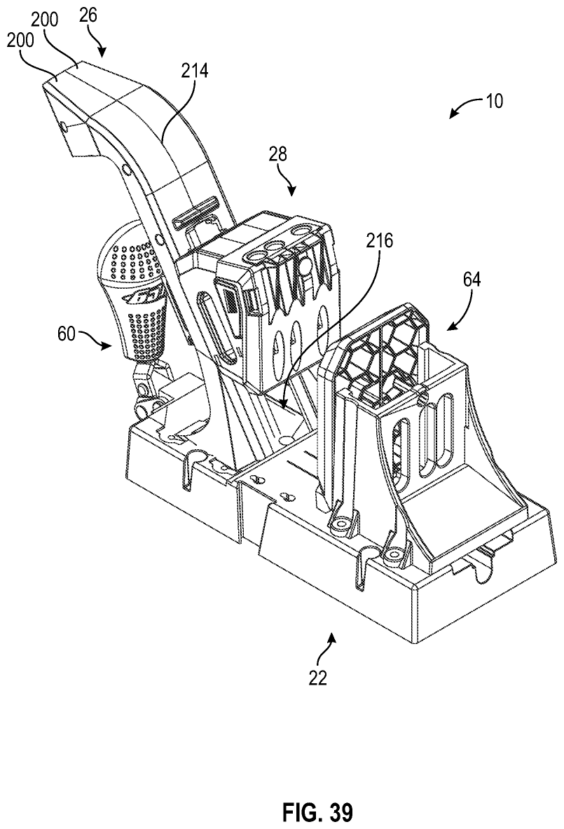

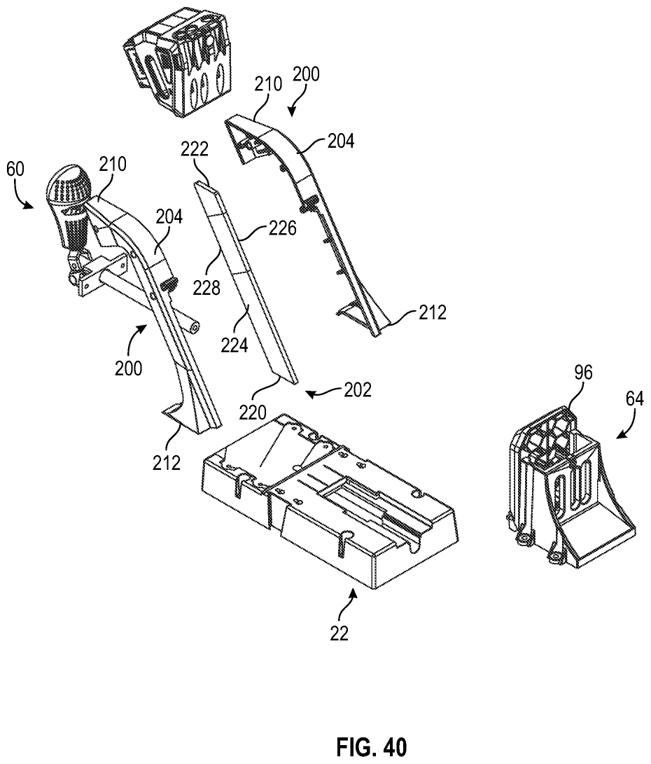

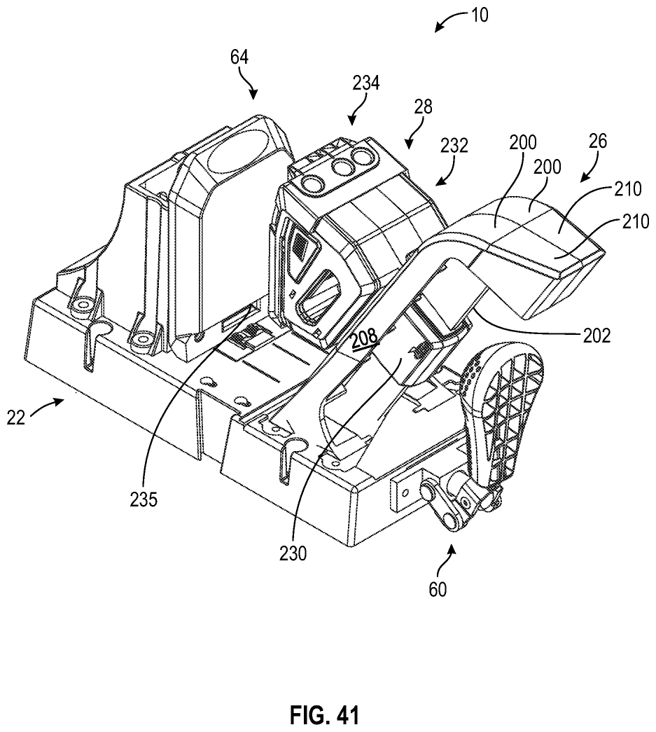

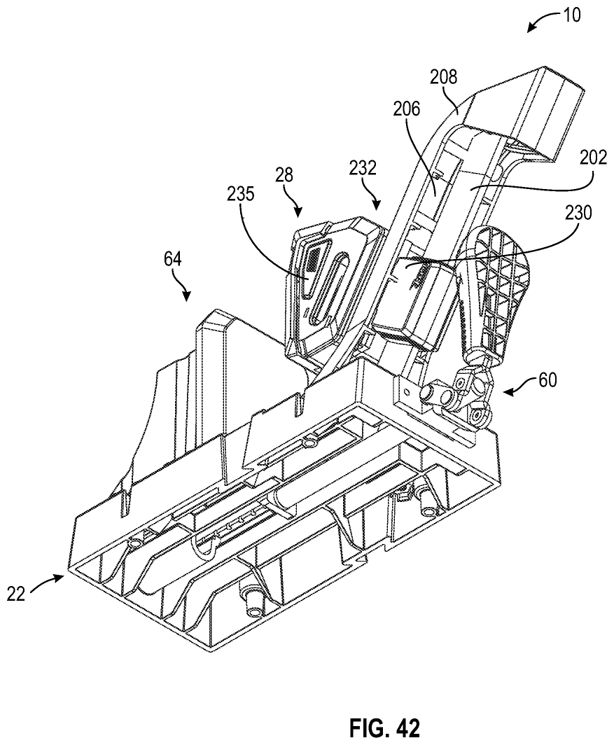

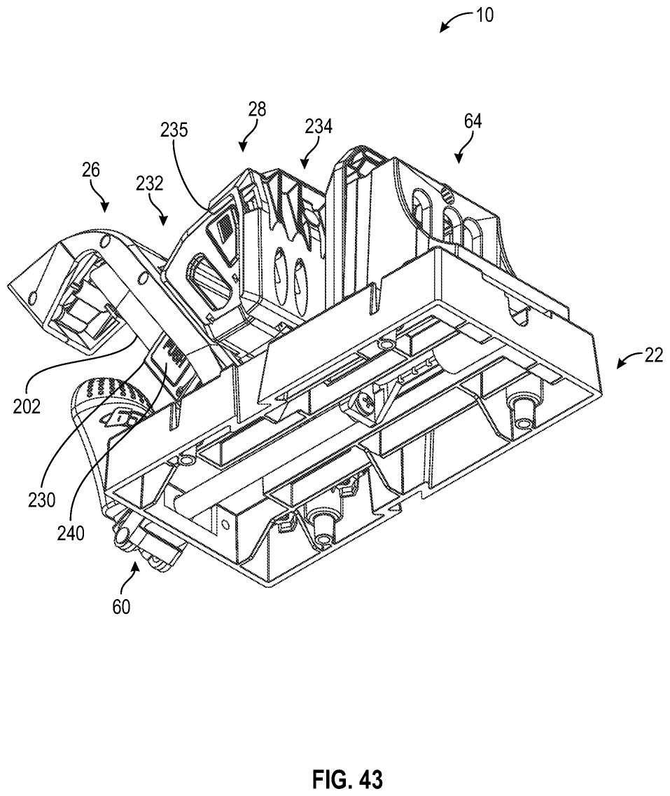

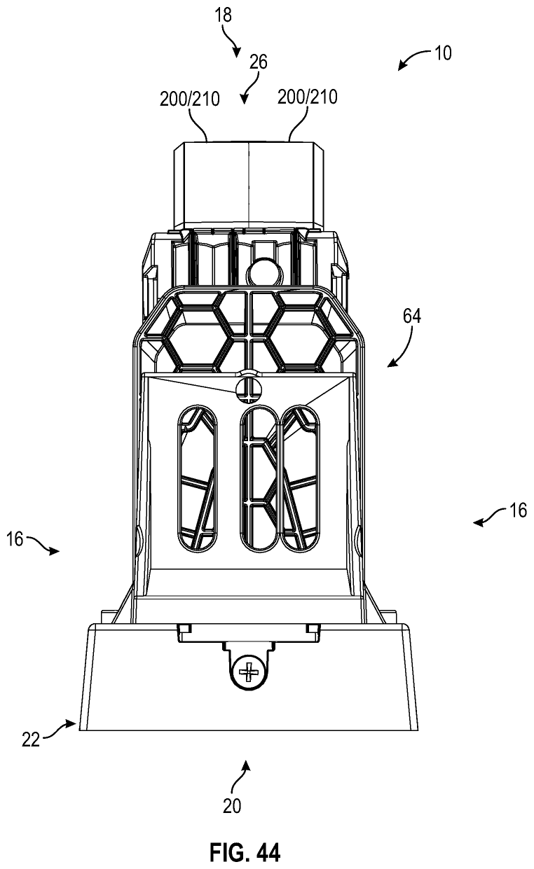

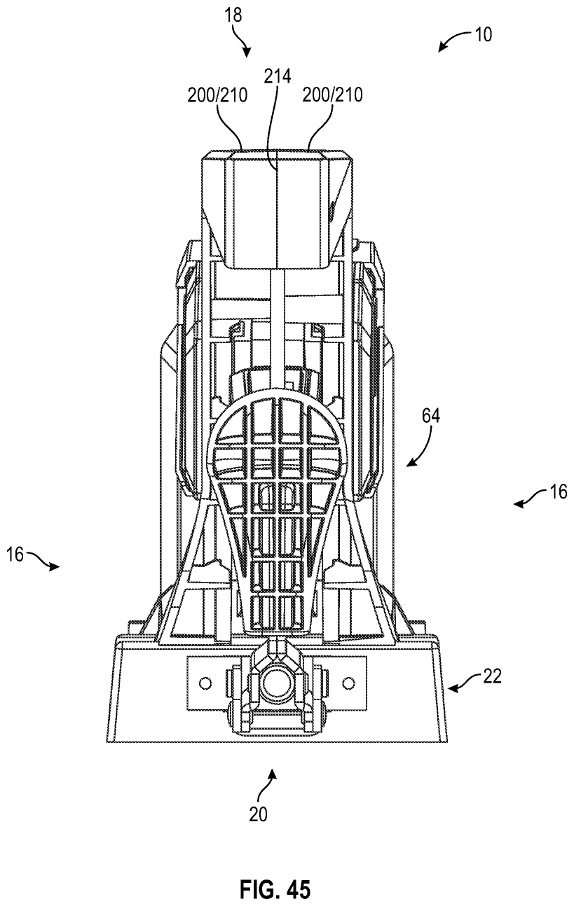

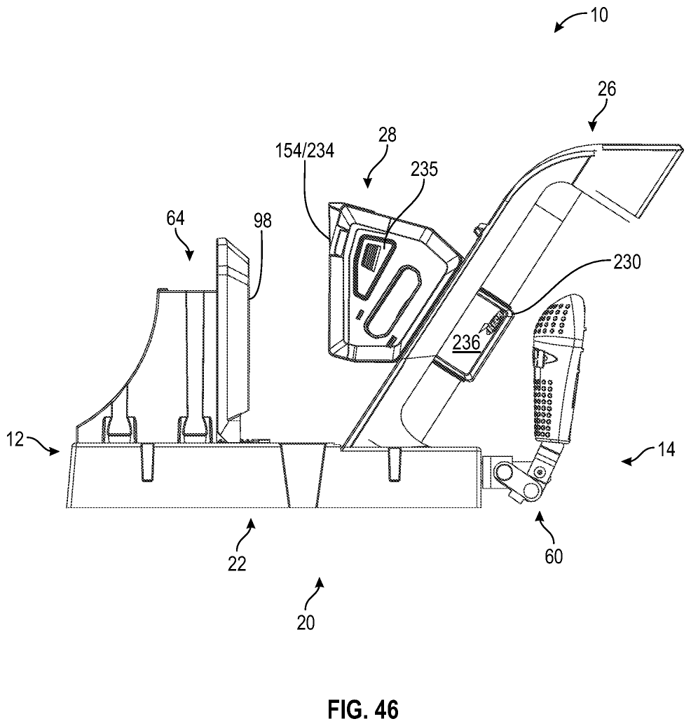

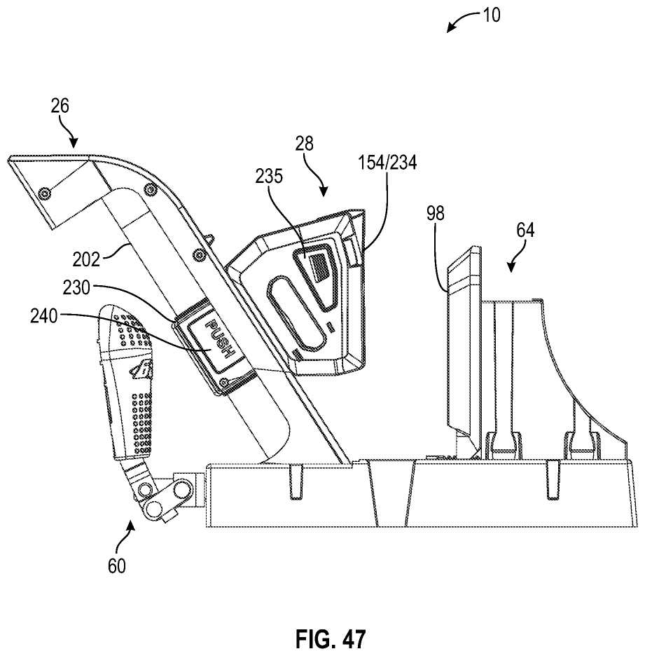

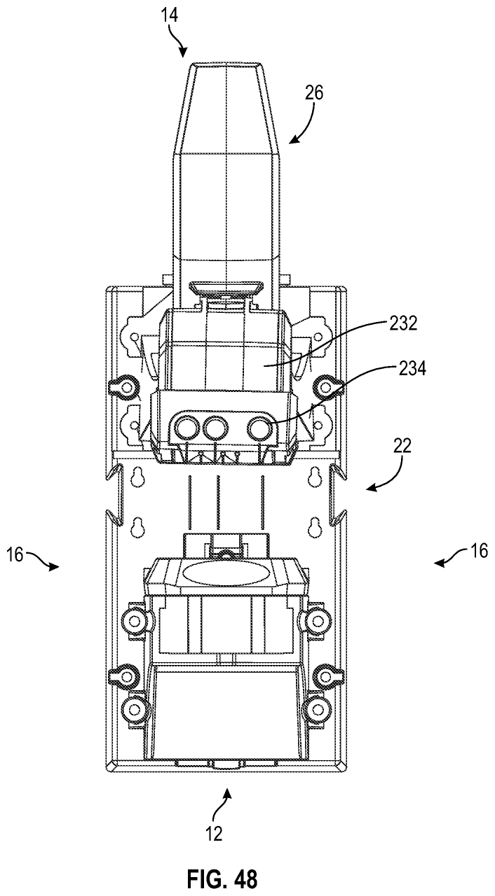

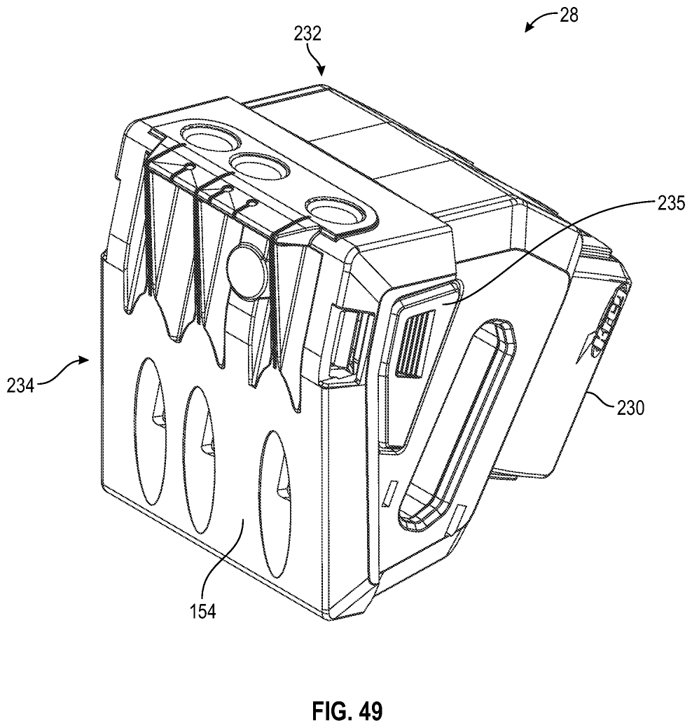

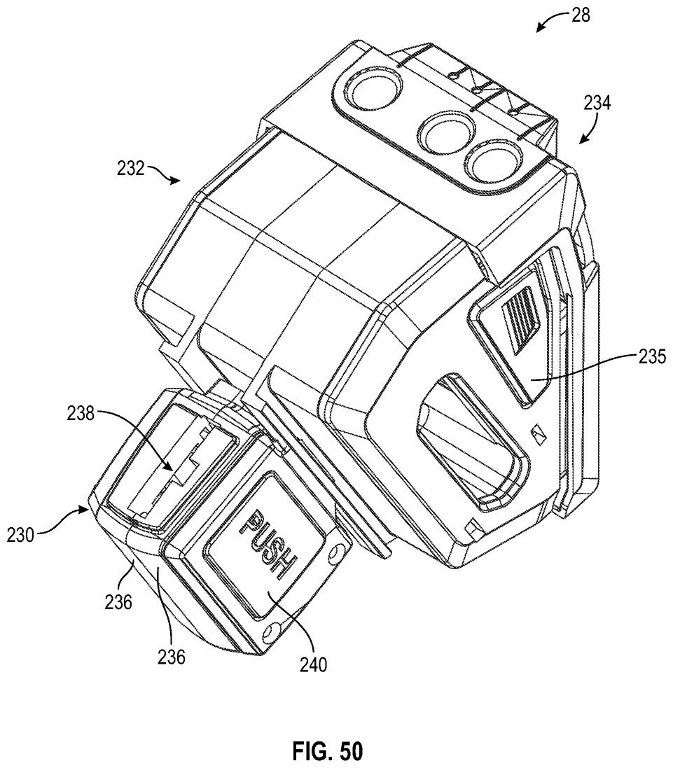

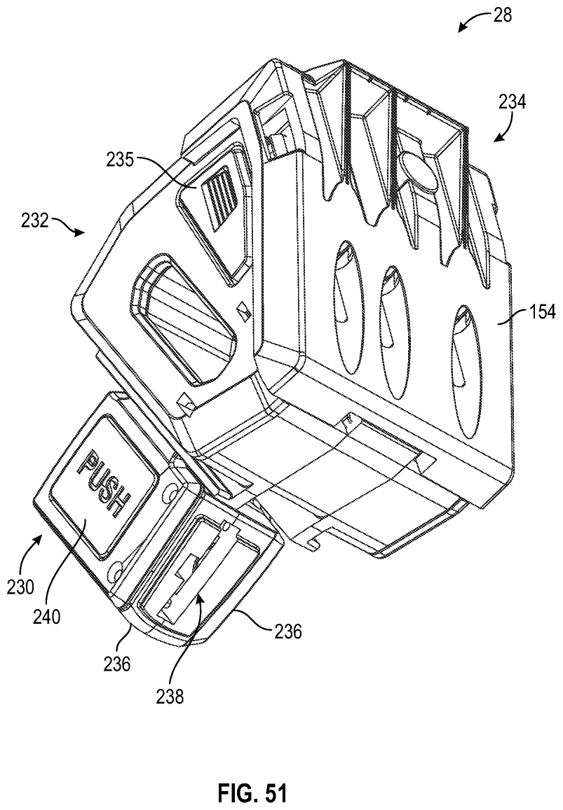

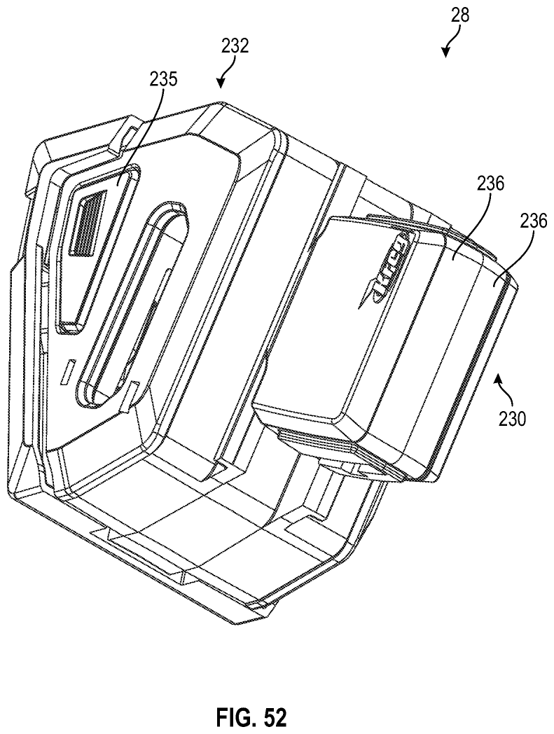

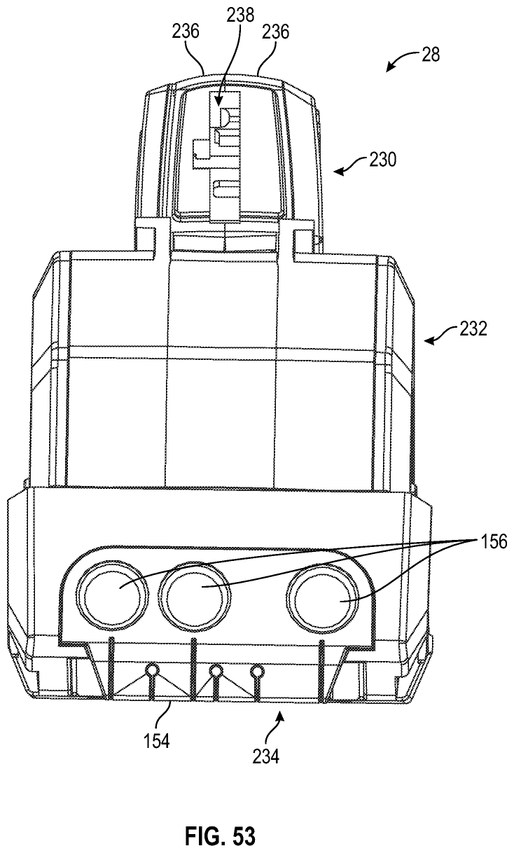

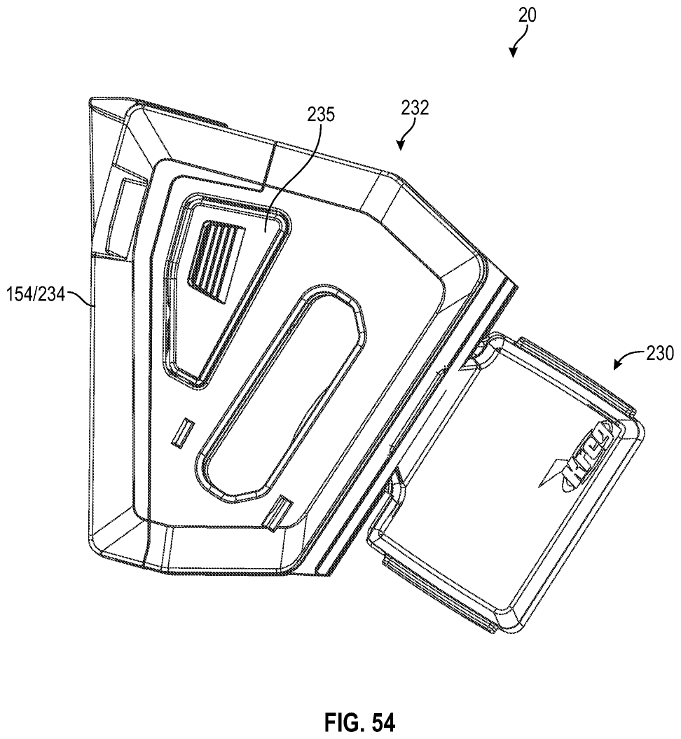

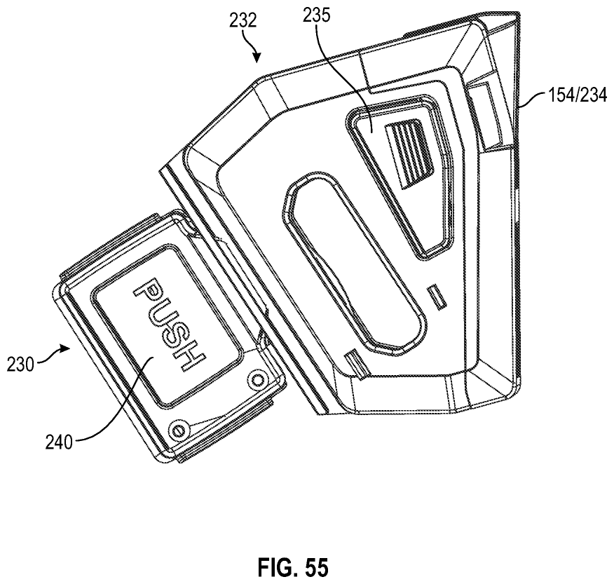

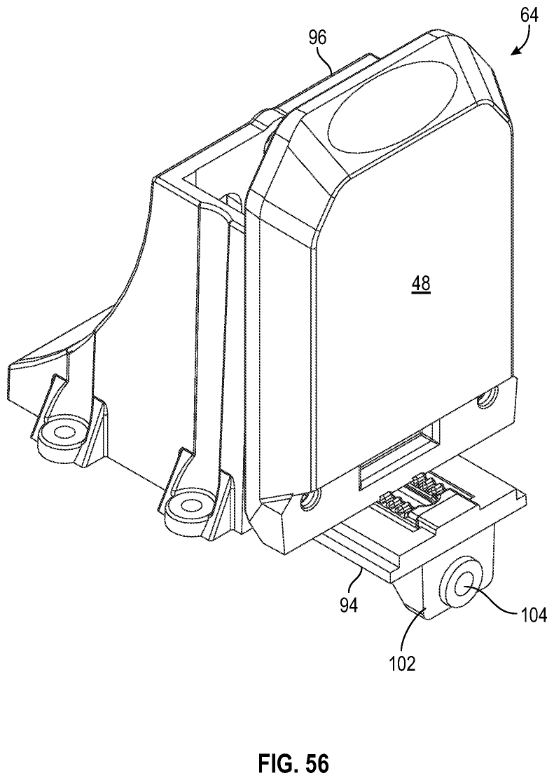

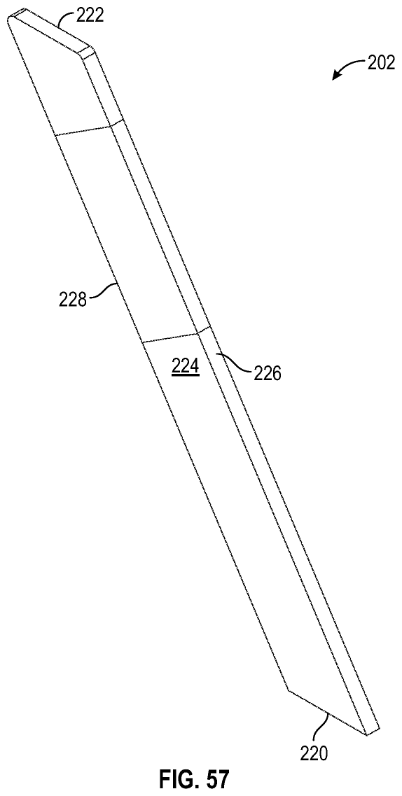

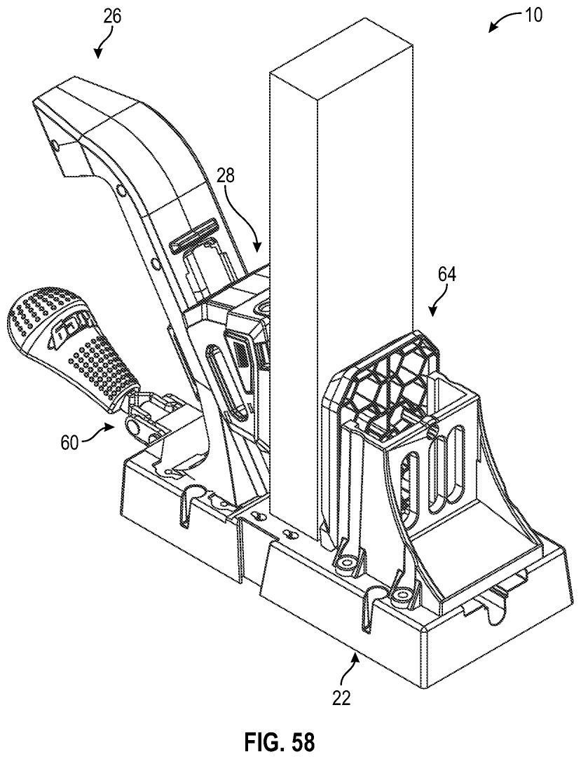

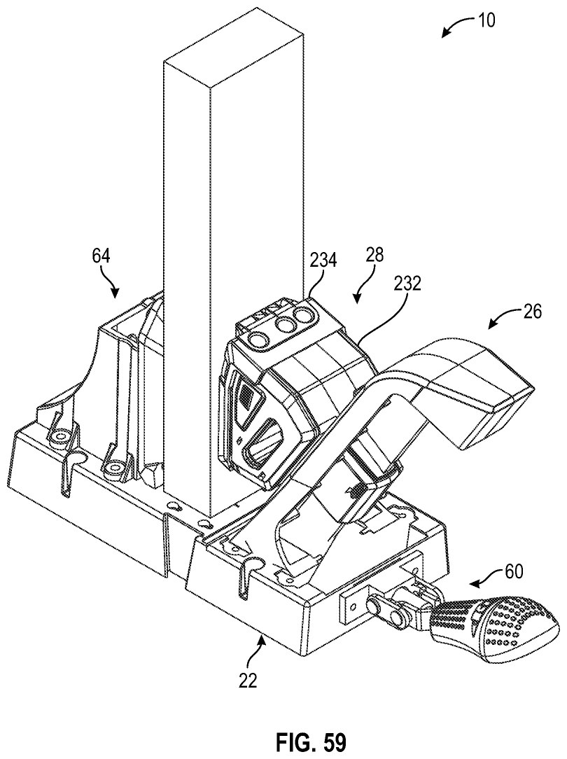

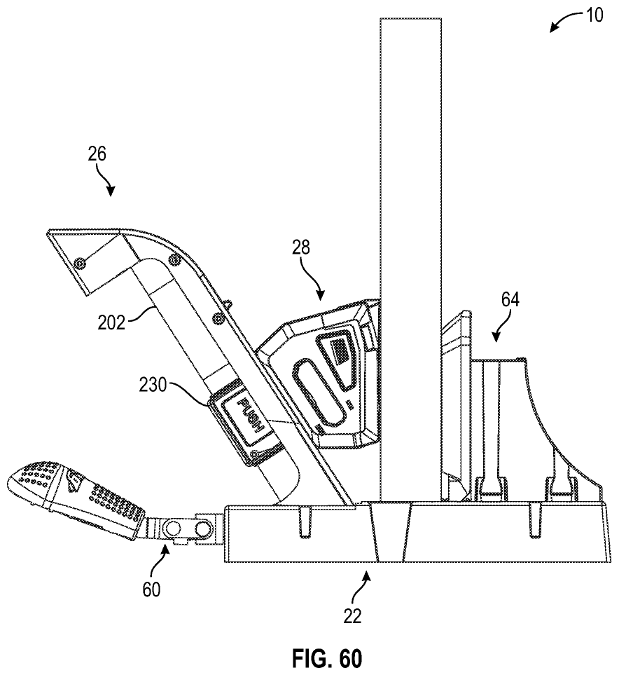

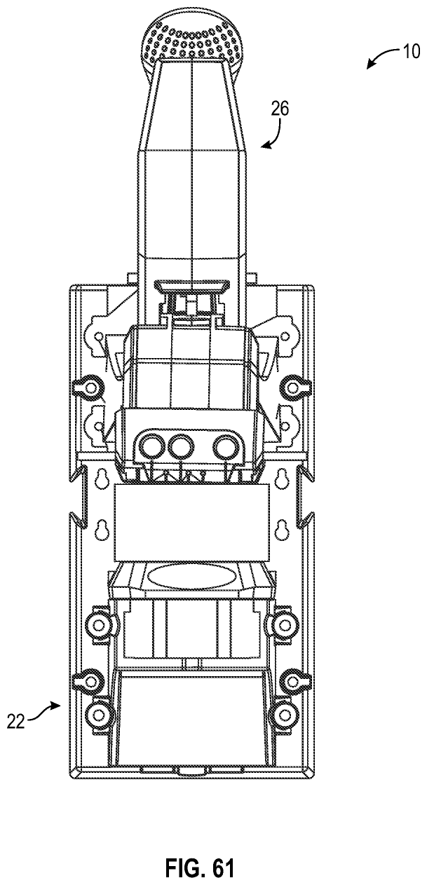

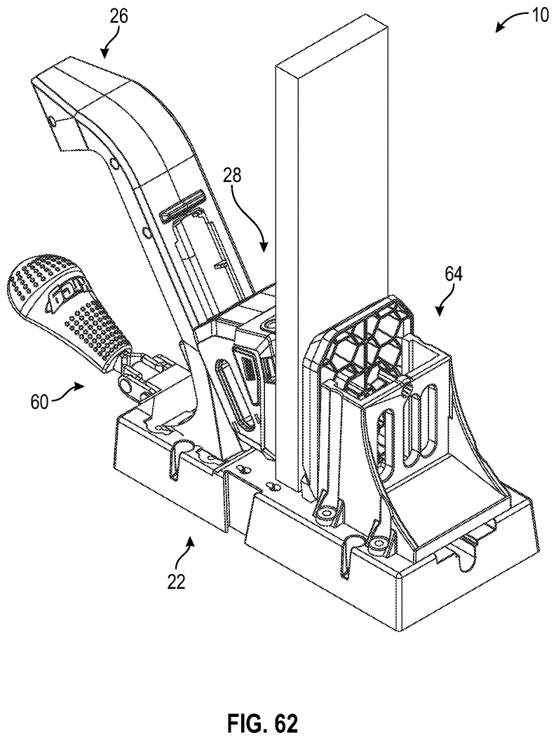

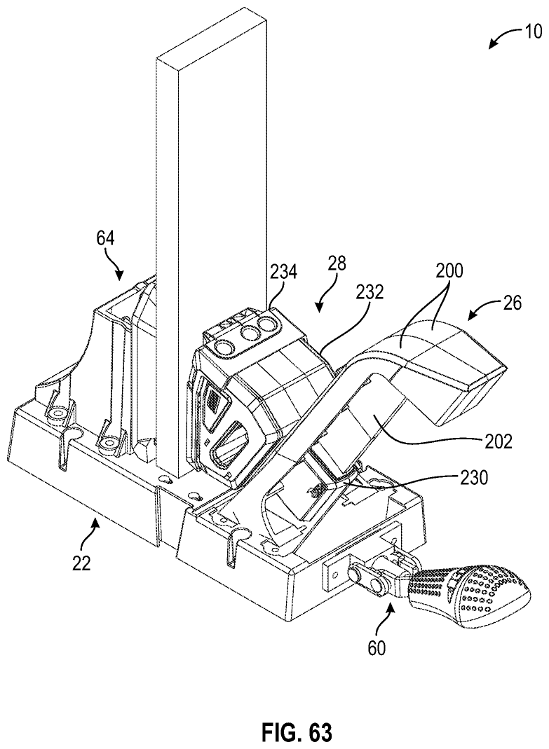

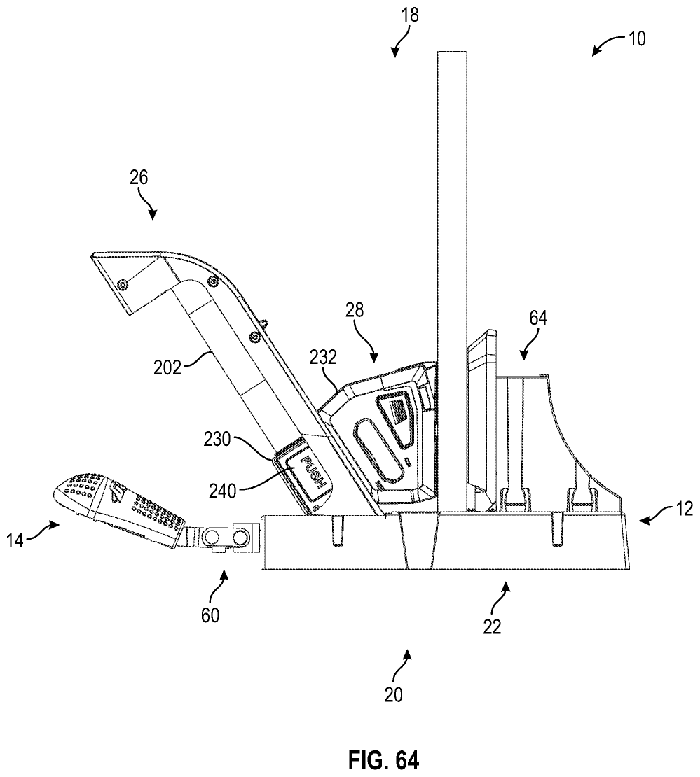

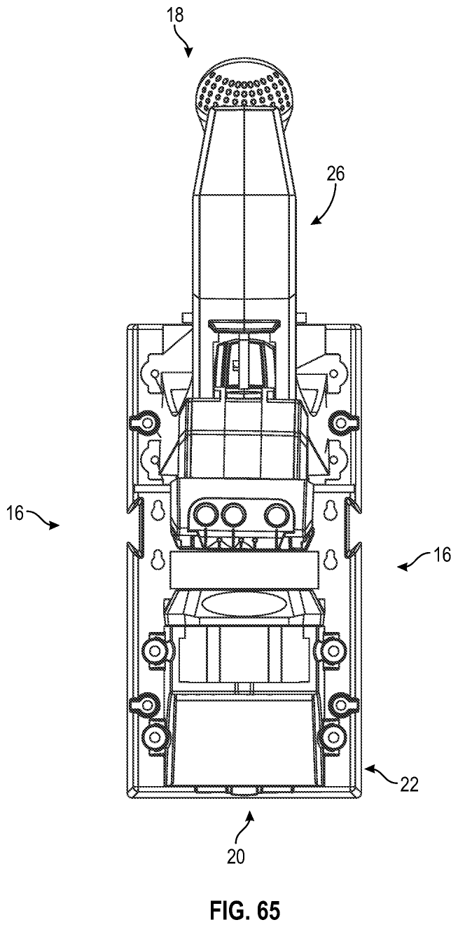

An alternative arrangement of system 10 is also presented in FIGS. 39-65. This alternative arrangement is similar to system 10 presented in FIGS. 1-38 and therefore, unless specifically stated otherwise herein, the prior teaching and disclosure shown in FIGS. 1-38 applies equally to the alternative arrangement shown in FIGS. 39-65. That is, the arrangement shown in FIGS. 39-65 is configured to be used with the same or similar base 22 and clamp assembly 24 with the primary difference relating to upright assembly 26 and the engagement member 230 of drill guide assembly 28.

### Clamping Assembly 24

In the arrangement shown in FIGS. 39-65, the clamping assembly 24 is generally the same as that described herein with reference to FIGS. 1-38. However, the shape and design of workpiece support member 64 is slightly different in FIGS. 39-65 than the workpiece support member 64 in FIGS. 1-38. The difference in shape and design of the workpiece support member 64 is largely insubstantially and the workpiece support member shown in FIGS. 39-65 still has a base plate 94, a body, 96, and a clamping face 98 as shown and described herein with reference to FIGS. 1-38.

### Upright Assembly 26

In the arrangement shown in FIGS. 39-65, system 10 includes an upright assembly 26. Upright assembly 26 is formed of any suitable size, shape, and design and is configured to support drill guide assembly 28. In the arrangement shown, as one example, upright assembly 26 also provides a path along which drill guide assembly 28 travels. In the arrangement shown, as one example, upright assembly 26 includes a pair of covers 200 and a guide 202.

In the arrangement shown in FIGS. 39-65 as one example, upright assembly 26 is formed of multiple pieces that are connected or assembled to one another through bolting, however any other means of connecting or assembling the multiple pieces may be used, including adhesion, screwing, welding, friction fitting, or the like. Alternatively, upright assembly 26 may be formed of a single, unitary member that is formed in a manufacturing process such as injection molding, casting, machining, extrusion, forming, additive manufacturing, or the like to form a unitary and monolithic member. In the arrangement shown in FIGS. 39-65 as one example, upright assembly 26 is formed primarily of a non-metallic material such as a plastic material, a fiberglass material, or any other non-metallic material and/or composite thereof. Alternatively, upright assembly 26 may be formed of a metallic material such as steel, aluminum, chromium, or any other metallic material, alloy, and/or composite thereof.

In the arrangement shown in FIGS. 39-65 as one example, upright assembly 26 is a stationary member which is configured to be attached to base 22. In the arrangement shown in FIGS. 39-65 as one example, when viewed from either opposing side 16 of system 10, upright assembly 26 is a generally elongated member which extends upward from base 22 at an angle toward the rearward end 14 of system 10. As described herein with reference to FIGS. 1-38, the angle at which upward assembly 26 extends is important because drill guide assembly 28 must be placed accurately in order to create appropriate pocket holes in workpieces of various thicknesses. The angle at which upright assembly 26 extends upward allows for drill guide assembly 28 to be moved rearward and upward, or forward and downward, and be stopped at various positions which correspond to different workpiece thicknesses. That is, the angled of upright assembly 26 helps facilitate the proper placement of drill guide assembly 28 in order to accommodate for workpieces of varying thicknesses and drill appropriate pocket holes for the varying workpieces.

Covers 200: In the arrangement shown in FIGS. 39-65 as one example, upright assembly 26 includes a pair of covers 200. Covers 200 are formed of any suitable size, shape, and design and are configured to connect upright assembly 26 to base 22, and support guide 202. In the arrangement shown, as one example, a pair of covers 200 are provided which are configured to mate together and connect to guide 202 to form upright assembly 26. In the arrangement shown, as one example, each cover 200 includes a forward surface 204, a rearward surface 206, an exterior surface 208, an upper end 210, and a base plate 212. When the pair of covers 200 are brought together, a seamline 214 is present where the pair of covers 200 meet and a slot 216 is formed in upright assembly 26.

In the arrangement shown, as one example, the forward surface 204 of covers 200 is a generally flat and planar surface which extends at an angle upward from base 22 and toward the rearward 14 of system 10. In the arrangement shown, as one example, the rearward surface 206 of covers 200 is also a generally flat and planar member which extends in approximate parallel planar spaced relation to forward surface 204. In the arrangement shown, as one example, there may be structural features and engagement members adjacent the rearward surface 206 to provide support to upright assembly 26 and facilitate connection of the covers 200. In the arrangement shown, as one example, the exterior surface 208 of covers 200 is a generally flat and planar surface which extends in approximate perpendicular relation to forward surface 204 and rearward surface 206. In the arrangement shown, as one example, the forward surface 204, rearward surface 206, and exterior surface 208 extend a distance upward from base plate 212 to upper end 210.

In the arrangement shown, as one example, covers 200 includes a base plate 212. Base plate 212 is formed of any suitable size, shape, and design and is configured to facilitate connection of upright assembly 26 to base 22. In the arrangement shown, as one example, base plate 212 is a generally rectangular and planar member which extends rearward from the forward surface 204 of covers 200. In the arrangement shown, as one example, the side of base plate 212 adjacent the exterior surface 208 of covers 200 engages with at least a portion of the edges 52 of recessed platform 48 of base 22 in order to properly position upright assembly 26 and help facilitate secured engagement of upright assembly 26 to base 22. In the arrangement shown, as one example, base plate 212 may be connected to base 22 through any number of fasteners or connection means, such as screws, bolts, rivets, adhesion, friction fitting, or any other method of joining two members together.

In the arrangement shown, as one example, when the pair of covers 200 are brought together, a seamline 214 is created on the forward surface of the combined covers 200. Additionally, a slot 216 is formed in the forward surface. Slot 216 is formed of any suitable size, shape, and design and is configured to allow the engagement member 230 of drill guide assembly 28 to engage with guide 202 on the rearward side of covers 200 while also allowing the clamping face 154 of drill guide block 234 of drill guide assembly 28 to be positioned on forward side of covers 200. In the arrangement shown, as one example, slot 216 extends upward a distance from the base plate 212 of covers 200. In the arrangement shown, as one example, slot 216 also acts as a stop member which prevents drill guide assembly 28 from traveling beyond a certain point along guide 202 of upright assembly 26 by contacting engagement member 230 of drill guide assembly 28 when engagement member 230 reaches the upper end of slot 216.

In the arrangement shown, as one example, when covers 200 are brought together, they also engage with guide 202. In the arrangement shown, as one example, guide 202 is generally co-linear with the seamline 214 created when the covers 200 are brought together. With covers 200 brought together and held in engagement with one another and guide 202, upright assembly 26 is formed.

Guide 202: In the arrangement shown, as one example upright assembly 26 includes guide 202. Guide 202 is formed of any suitable size, shape, and design and is configured to engage drill guide assembly 28 and provide a path along which drill guide assembly 28 is able to slide. In the arrangement shown, as one example, guide 202 is a generally planar member which extends a length between its bottom surface 220 to its top surface 222, a width between opposing side surfaces 224, and a depth between its forward surface 226 and its rearward surface 228.

In the arrangement shown, as one example, the bottom surface 220 of guide 202 is configured to engage with or be mated against the recessed platform 48 of base 22. In the arrangement shown, as one example, the top surface 222 is configured to engage with or be mated against the lower (or interior) side of upper end 210 of covers 200. In the arrangement shown, as one example, the forward surface 226 of guide 202 is configured to engage with or be mated against at least a portion of the rear surface 206 of covers 200.

In the arrangement shown, as one example, the engagement member 230 of drill guide assembly 28 is configured to extend around guide 202 and engage with guide 202. Said another way, guide 202 is configured to pass through the aperture 238 of engagement member 230 of drill guide assembly 28 and engage with engagement member 230 of drill guide assembly 28 thereby facilitating connection of upright assembly 26 to drill guide assembly 28 and providing a path along which drill guide assembly 28 travels.

While upright assembly 26 and its components have been described according to the arrangement shown in FIGS. 39-65, as one example, it will be understood by those skilled in the art that any other configuration, combination, or variation of upright assembly 26 and its components may be used in order to support drill guide assembly 28 and provide a path along which drill guide assembly 28 can travel.

Drill Guide Assembly 28

In the arrangement shown in FIGS. 39-65 as one example, system 10 includes a drill guide assembly 28. The drill guide assembly 28 presented in FIGS. 39-65 is similar to the drill guide assembly 28 presented in FIGS. 1-38 with the exception of engagement member 230. In the arrangement shown in FIGS. 39-65, drill guide assembly 28 includes engagement member 230 in lieu of engagement members 144 (and their components) shown in FIGS. 1-38. In the arrangement shown, as one example, drill guide assembly 28 has a body 232 and a drill guide block 234. In the arrangement shown, as one example, body 232 is similar to body 134 shown in FIGS. 1-38 and drill guide block 234 is similar to drill guide block 136 shown in FIGS. 1-38, and body 232 and drill guide block 234 perform the same functions as body 134 and drill guide block 136, respectively. However, in the arrangement shown, as one example, rather than providing arms on the side surfaces of body 232, a biasing member 235 is provided which is configured to facilitate engagement between body 232 and drill guide block 234. That is, drill guide block 234 is positioned adjacent body 232 and a portion of body 232 will extend past the rearward side of drill guide block 234 and biasing member 235 will be provided on the portion of body 232 extending past he rearward side of drill guide block 234. The biasing member 235, when in its resting state, will force internal components (not shown) of biasing member 235 into contact with the sides of drill guide block 234, thereby holding drill guide block 234 in secured engagement with body 232.

In the arrangement shown, as one example, drill guide assembly 28 includes engagement member 230. Engagement member 230 is formed of any suitable size, shape, and design and is configured to facilitate engagement with guide 202 of upright assembly 26. In the arrangement shown, as one example, engagement member 230 includes two halves 236, an aperture 238, and a spring biased member 240. In the arrangement shown, as one example, engagement member 230 is a generally rectangular member formed by bringing the two halves 236 of engagement member 230 together. When the two halves 236 of engagement member 230 are brought together, there is an aperture 238 through the middle of engagement member 230. In the arrangement shown, as one example, guide 202 of upright assembly 26 is configured to pass through aperture 238 of engagement member 230.

In the arrangement shown, as one example, when guide 202 is passed through aperture 238 of engagement member 230, engagement member 230 is restricted in its path of travel to the path generally parallel to guide 202. That is, when engagement member 230 is extended around guide 202, engagement member 230 may only travel along guide 202 either downward and forward or upward and rearward. In the arrangement shown, as one example, aperture 238 is generally larger than guide 202 which allows engagement member 230 to easily slide along guide 202. However, engagement member 230 must be able to tightly and securely engage guide 202 to remain stationary when a user is using drill guide assembly 28 to drill pocket holes in a workpiece. Therefore, spring biased member 240 is provided.

In the arrangement shown, as one example, engagement member 230 includes a spring biased member 240. Spring biased member 240 is formed of any suitable size, shape, and design and is configured to facilitate selective secured engagement between engagement member 230 and guide 202. In the arrangement shown, as one example, when in use drill guide assembly 28 must remain stationary along guide 202. In the arrangement shown, as one example, spring biased member 240, when in its resting state, causes an internal member (not shown) of spring biased member 240 to push tightly against guide 202 and, thereby, facilitate secured connection with guide 202. In the arrangement shown, as one example, when a user pushed inward on spring biased member 240, the internal members (not shown) of spring biased member 240 will disengage from guide 202 and engagement member 230 can be easily moved along guide 202 in order to accommodate for workpieces of various thicknesses.

### In Operation

The system 10 presented in FIGS. 39-65 is operated similarly to the system 10 presented in FIGS. 1-38 in order to drill pocket holes in a workpiece. That is, a user will pick out a desired workpiece with a certain thickness. Prior to clamping the workpiece, the user will adjust drill guide assembly 28 by moving it along guide 202. The user will push inward on the spring biased member 240 of engagement member 230 of drill guide assembly 28, thereby disengaging engagement member 230 from guide 202. The user can then move drill guide assembly 28 upward and rearward along guide 202 (to accommodate for workpieces of greater thickness) or downward and forward along guide 202 (to accommodate for workpieces of lesser thickness). Once drill guide assembly 28 is at the desired position corresponding to the selected workpiece thickness, the user will release spring biased member 240, which will cause engagement member 230 to once again be in engagement with guide 202 and held in place.

Once the drill guide assembly 28 is in the desired position, the user can position the workpiece between the clamping face 154 of drill guide block 234 of drill guide assembly 28 and clamping face 98 of workpiece support member 64 of clamping assembly 24. The user will then move handle 68 of handle portion 60 of clamp assembly 24 downward. As handle 68 of handle portion 60 is moved downward, the arms 72 of handle portion are moved, causing the first axle 74 of handle portion 60 to move rearward. As the first axle 74 of handle portion 60 moves rearward, rod 62 of clamp assembly 24 is forced to move rearward, which in turn forces workpiece support member 64 to move rearward and into a fully clamped position. With the workpiece support member 64 in the fully clamped position, the workpiece will be clamped within close and tight tolerances between clamping face 154 of drill guide block 234 of drill guide assembly 28 and clamping face 98 of workpiece support member 64 of clamping assembly 24.

Once the workpiece is properly clamped, the user can then use a drill and stepped drill bit to form a pocket hold in the workpiece. The user can insert the drill bit into and through the guide channels 156 of drill guide block 234 of drill guide assembly 28. Once the drill bit is extended through the guide channels 156, it will exit the guide channels 156 through bore openings 158. The user will then insert the drill bit into the workpiece a desired distance to form the pocket hole.

What is claimed:

1. A pocket hole jig system for drilling a pocket hole in a workpiece, the system comprising:
a base;
the base having an upper surface that forms a generally planar work surface;
an upright assembly;
the upright assembly operably connected to the base;
a clamping assembly;
the clamping assembly operably connected to the base;
the clamping assembly having a handle assembly;
the clamping assembly having a workpiece support member;
a drill guide assembly;
the drill guide assembly operably connected to the upright assembly;
wherein the upright assembly is fixed in place on the base;
wherein the upright assembly includes a guide;
wherein the guide provides a path of travel for the drill guide assembly at an angle downward and forward towards the workpiece support member and upward and away from the workpiece support member;
wherein operation of the clamping assembly causes movement of the workpiece support member in a path substantially parallel to the generally planar work surface of the upper surface of the base.

2. The system of claim 1, wherein a clamping face of the drill guide assembly and a clamping face of the workpiece support member are configured to clamp a workpiece therebetween.

3. The system of claim 1, wherein a clamping face of the drill guide assembly and a clamping face of the workpiece support member are configured to clamp a workpiece therebetween and wherein the drill guide assembly is adjusted to correspond to a thickness of the workpiece.

4. The system of claim 1, wherein the generally planar work surface of the upper surface of the base is configured to support an end of the workpiece.

5. The system of claim 1, wherein the guide extends outward in a generally planar fashion from a rearward side of the upright assembly.

6. The system of claim 1, wherein the guide is formed of a pair of rails which extend outward from upright assembly at opposing sides of the upright assembly.

7. The system of claim 1, wherein the drill guide assembly includes an engagement member configured to engage with and slide along the guide of the upright assembly.

8. The system of claim 1, wherein the drill guide assembly is configured to stop at a plurality of predetermined positions along the guide of the upright assembly.

9. The system of claim 1, wherein the guide includes a plurality of recesses, and wherein the plurality of recesses along the guide correspond to predetermined workpiece thicknesses.

10. A pocket hole jig system for drilling a pocket hole in a workpiece, the system comprising:
a base;
the base having an upper surface that forms a generally planar work surface;
an upright assembly;
the upright assembly operably connected to the base;
a clamping assembly;
the clamping assembly operably connected to the base;
the clamping assembly having a handle;
the clamping assembly having a workpiece support member;
a drill guide assembly;
the drill guide assembly operably connected to the upright assembly;
wherein the upright assembly includes a guide;
wherein the guide provides a path of travel for the drill guide assembly at an angle downward and forward towards the workpiece support member and upward and away from the workpiece support member;
wherein the drill guide assembly is configured to stop at a plurality of predetermined positions along the guide of the upright assembly;
wherein operation of the handle on the clamping assembly causes movement of the workpiece support member in a path substantially parallel to the generally planar work surface of the upper surface of the base.

11. The system of claim 10, wherein a clamping face of the drill guide assembly and a clamping face of the workpiece support member are configured to clamp a workpiece therebetween.

12. The system of claim 10, wherein a clamping face of the drill guide assembly and a clamping face of the workpiece support member are configured to clamp a workpiece therebetween and wherein the drill guide assembly is adjusted to correspond to a thickness of the workpiece.

13. The system of claim 10, wherein the generally planar work surface of the upper surface of the base is configured to support an end of the workpiece.

14. The system of claim 10, wherein the guide extends outward in a generally planar fashion from a rearward side of the upright assembly.

15. The system of claim 10, wherein the guide is formed of a pair of rails which extend outward from upright assembly at opposing sides of the upright assembly.

16. The system of claim 10, wherein the drill guide assembly includes an engagement member configured to engage with and slide along the guide of the upright assembly.

17. The system of claim 10, wherein the plurality of predetermined positions correspond to typical workpiece thicknesses.

18. The system of claim 10, wherein the guide includes a plurality of recesses, and wherein the drill guide assembly is configured to stop at the plurality of recesses.

19. The system of claim 10, wherein the upright assembly is fixed in place on the base.

20. A pocket hole jig system for drilling a pocket hole in a workpiece, the system comprising:
a base;
an upright assembly;
the upright assembly operably connected to the base;
a clamping assembly;
the clamping assembly operably connected to the base;
the clamping assembly having a workpiece support member;
a drill guide assembly;
the drill guide assembly operably connected to the upright assembly;
wherein the drill guide assembly moves along a path that extends downward and forward along upright assembly or upward and rearward along upright assembly; and
wherein the workpiece support member moves a predetermined distance between a fully disengaged position and a fully clamped position.

21. The system of claim 20, wherein a clamping face of the drill guide assembly and a clamping face of the workpiece support member are configured to clamp a workpiece therebetween.

22. The system of claim 20, wherein a clamping face of the drill guide assembly and a clamping face of the workpiece support member are configured to clamp a workpiece therebetween and wherein the drill guide assembly is adjusted to correspond to a thickness of the workpiece.

23. The system of claim 20, wherein the base has a generally planar upper surface configured to support an end of the workpiece.

24. The system of claim 20, wherein the guide extends outward in a generally planar fashion from a rearward side of the upright assembly.

25. The system of claim 20, wherein the guide is formed of a pair of rails which extend outward from upright assembly at opposing sides of the upright assembly.

26. The system of claim 20, wherein the drill guide assembly includes an engagement member configured to engage with and slide along the guide of the upright assembly.

27. The system of claim 20, wherein the drill guide assembly is configured to stop at a plurality of predetermined positions along the guide of the upright assembly, and wherein the plurality of predetermined positions correspond to predetermined workpiece thicknesses.

28. The system of claim 20, wherein the guide includes a plurality of recesses, and wherein the drill guide assembly is configured to stop at the plurality of recesses.

29. The system of claim 20, wherein the upright assembly is fixed in place on the base.
